(19) United States
(12) Patent Application Publication
(10) Pub. No.: US 2026/0217396 A1
(43) Pub. Date: Jul. 30, 2026

(54) STERILE FILLING OF CONTAINERS

(71) Applicant: CELLEO BIOTECH PTY LTD, Melbourne, Victoria (AU)

(72) Inventors: David Thomas KNEEN, Melbourne (AU); Jonathan Simon William ELLIS, Melbourne (AU); Mark David ROB, Melbourne (AU); Philip James DUNCAN, Melbourne (AU)

(21) Appl. No.: 19/147,262

(22) PCT Filed: Jun. 30, 2023
(86) PCT No.: PCT/AU2023/050614

§ 371 Date: Jul. 10, 2025

Related U.S. Application Data
(60) Provisional application No. 63/479,519, filed on Jan. 11, 2023.

(51) Int. Cl. B65B 3/00; A61J 1/14; B65B 3/30; B65B 7/16

(52) U.S. Cl. CPC B65B 3/003; A61J 1/1406; A61J 1/1418; A61J 1/1431; A61J 1/1475; B65B 3/30; B65B 7/16

(57) ABSTRACT

A system for sterile filling of containers comprises a fluid source receiver for receiving fluid to be filled into the containers; a retaining member configured to retain a plurality of containers, wherein the plurality of containers are in fluid communication with a manifold having a plurality of manifold limbs and wherein the manifold is configured to provide a flow path between a fluid source received by the fluid source receiver and ones of the plurality of containers; a pumping mechanism operable to introduce fluid into the containers via the flow path; and a sealing mechanism operable to seal the containers from the fluid source. The retaining member comprises one or more spacing members defining spaces arranged to limit container expansion during filling to achieve a target fill volume for at least one of the plurality of containers.

### TECHNICAL FIELD

The present invention relates to sterile filling of containers. It relates particularly but not exclusively to systems and methods for sterile filling of containers such as fluid bags and vials. In addition the present invention relates to vials suitable for sterile filling of fluids.

### BACKGROUND OF INVENTION

For many years, sterile therapeutic fluids such as saline, antibiotics, analgesics and other medicines have been stored in containers such as bags, vials and tubes ready for safe, sterile administration of therapies to human and animal patients. In many cases, these fluids can be sterilised after filling of the containers by autoclave or other techniques. This is possible only where the sterilisation technique does not damage or deteriorate the contents of the container.

Modern science has led to the development of biological therapies involving introduction of material such as cells, tissue, viruses, DNA, RNA, antibodies and the like to the subject by injection or other means. Modern cell therapies offer strategies for introduction of new and active cells to restore compromised or deteriorated tissue and organ structures and have the potential to treat diseases including cancers, infections and autoimmune indications. Because the cell therapy product contains living cells, sterilisation by autoclave and other techniques causing cell damage and death are not useful. Therefore, a challenge for delivery of cell therapies is to package and deliver fluid containing the cell product to the patient in a sterile, precise, rapid and cost effective manner.

Current techniques for formulation of cell products and filling of containers are largely manual and open, typically requiring movement of the cell product from one system for formulation (e.g. mixing the cell substance with a cryopreservative solution) to another system for filling the mixed cell product into containers suitable for use such as in patient administration, quality control and sample retention. While manual processes are undertaken by skilled operators in high-grade clean rooms, issues can arise with product variability. Manual processing also presents septic exposure risks and challenges for temperature control. Importantly the manual filling process is tedious and slow, making it prone to human error. There is also risk of cell damage and death due to extended exposure to cytotoxic cryopreservative prior to the formulated cell product being cryogenically preserved (frozen) for storage and/or distribution which can impact yield and product profile. These issues present potential for detrimental impact on patient safety and efficacy of therapy.

It would be desirable to provide an approach to sterile filling of containers which addresses or ameliorates one or more shortcomings of the current techniques, or at least provides an alternative.

The discussion of the background to the invention included herein including reference to documents, acts, materials, devices, articles and the like is included to explain the context of the present invention. This is not to be taken as an admission or a suggestion that any of the material referred to was published, known or part of the common general knowledge as at the priority date of any of the claims.

### SUMMARY OF INVENTION

Viewed from one aspect, the present disclosure provides a system for sterile filling of containers, the system comprising: a fluid source receiver for receiving fluid to be filled into the containers; a retaining member configured to retain a plurality of containers, wherein the plurality of containers are in fluid communication with a manifold having a plurality of manifold limbs and wherein the manifold is configured to provide a flow path between a fluid source received in the receiver and ones of the plurality of containers; a pumping mechanism operable to introduce fluid into the containers via the flow path; and a sealing mechanism operable to seal the containers from the fluid source; wherein the retaining member comprises one or more spacing members defining spaces arranged to limit container expansion during filling to achieve a target fill volume for at least one of the plurality of containers.

In some embodiments, the flow path between the fluid source and the plurality of containers is a closed fluid system preventing entry of contaminants during use of the system to fill the plurality of containers.

In some embodiments, the spaces are adjustable. The spacing members may comprise walls defining spaces for accommodating individual ones of the plurality of containers therebetween although it is contemplated that more than one (e.g. two) containers may be accommodated in a space between walls. In some embodiments, at least every second wall is moveable. Movable walls may move in concert, or they may be configured to move independently of each other.

The walls may each be of uniform thickness although that need not be the case. In some embodiments, some of the walls, such as at least every second wall or in some cases, all walls, are configured to define a non-uniform space between adjacent walls so as to control the size of the space by relative movement between the container and the wall, such as by moving the container while keeping the wall stationery (or vice versa).

In some embodiments, the system comprises a user interface, a controller in operable communication with the user interface wherein the controller is operable to control components of the system, and a memory storing instructions executed by a processor of the controller. The controller may be configured to determine a required spacing between the walls to achieve the target fill volume for at least one of the plurality of containers. Alternatively/additionally the controller may be configured to determine a different defined space to achieve a different target fill volume for at least one of the plurality of containers.

In some embodiments, the controller may be configured to control operation of the pumping mechanism. The controller may be configured to operate the pumping mechanism to evacuate the containers prior to filling. In some embodiments, the system comprises a fluid pressure sensor in the flow path, wherein controller is configured to control operation of the pumping mechanism to stop filling when the fluid pressure sensor determines a target pressure has been reached.

In some embodiments, the system is configured to receive a rack carrying the plurality of containers to be filled. The rack may also be removable with the sealed containers. In some embodiments, the rack comprises one or more articulating members configured to orient the plurality of containers substantially parallel to the rack.

In some embodiments, the system comprises a mixing reservoir receiving at least one fluid for mixing before filling into the plurality of containers. The mixing reservoir may be temperature controlled. Alternatively/additionally the mixing reservoir may comprise at least one thermally conductive member.

In some embodiments, the system is temperature controlled. Temperature control may occur e.g. by management of air temperature within a closable housing of the system, and/or by localised thermal conduction. Localised thermal conduction may be introduced in one or more locations within the system for achieving a desired fluid temperature, such as at one or more fluid source receivers and/or the mixing reservoir and/or tubing through which fluid flows in the system.

In some embodiments, the sealing mechanism comprises one or more of an impulse, radio frequency or heat sealing mechanism configured to seal individual ones of the containers. Alternatively/additionally the sealing mechanism may comprise a crimping mechanism configured to seal individual ones of the containers. The sealing mechanism may also detach the sealed containers from the manifold, or this may be achieved using a separate cutting/separating mechanism.

In some embodiments, the system is operable to fill ones of the containers to a different target volume from others of the containers in fluid communication with the manifold. In some embodiments, the containers on a manifold comprise sterile flexible bags.

The system may be configured to receive more than one manifold simultaneously. For example, system may accommodate multiple manifolds fluidly coupled with the flow path via a hub, and/or by a branched conduit. In some embodiments, the system may be configurable to fill containers comprising bags in fluid communication with a first manifold and vials in communication with a second manifold, wherein the bags and vials are filled from a common fluid source.

In some embodiments, the system may be configurable to fill a subset of containers in fluid communication with a manifold. Alternatively/additionally the system may be configurable to alter the target fill volume by controlling one or more of fluid pressure in the flow path, flow rate and time, and separation between spacing members of the retaining member. Alternatively/additionally the system may be configurable to fill containers having different type or capacity to a target volume.

In some embodiments, the containers on a manifold may comprise substantially rigid sterile vials in fluid communication with ones of the manifold limbs of the manifold. In some embodiments the substantially rigid sterile vials comprise a neck portion. The neck portion or part thereof may comprise a cross-sectional shape selected from a group comprising a: circle, oval, ellipse and obround. In some embodiments, an oval cross section may facilitate sealing and/or cutting. In some embodiments, the vials may each comprise a vial wall around at least part of the neck portion, the vial wall comprising an opening for receiving the sealing mechanism to seal the neck portion. The vial wall may provide a base for standing the vial when filled and detached from the manifold.

In some embodiments, each vial may comprise a neck portion and optionally, a shield around at least part of the neck portion, the shield configured to protect at least part of the neck portion e.g. from deformation or heat. In such embodiments, the manifold may comprise one or more recessed regions, each recessed region being aligned with a corresponding vial opening and configured to receive a sealing head which deforms the recessed region, e.g. by melting, to seal the respective vial opening.

In some embodiments, the vials each comprise a primary closure such as e.g. a screw top, a sealed septum, a welded lid or a tear away seal to name a few. In some embodiments, the substantially rigid vial may comprise one or more sterile access ports provided through the primary closure. In some embodiments, the primary closure may not be removable from the vial.

The vials may further comprise a secondary closure beneath the primary closure. The secondary closure may comprise e.g. a ring-pull seal, a tear-away seal such as a removable foil seal, or a septum which may be pierced.

An aspect of the disclosure provides a container filled with fluid using the system of the previous aspect.

Viewed from another aspect, the present disclosure provides a method for sterile filling of containers in a filling system, comprising the steps of: arranging a plurality of the containers in the system, the plurality of containers each being in fluid communication with a manifold via a corresponding manifold limb; coupling the manifold with a flow path providing closed fluid communication between a fluid source and the plurality of containers; providing a flow of the fluid into the one or more containers via the manifold until a target fill volume is reached; and sealing the containers; wherein arranging the plurality of containers comprises locating one or more containers between spacing members arranged to limit container expansion during filling. The plurality of containers may comprise sterile flexible bags.

The closed fluid flow path between the fluid source and the plurality of containers defines a barrier that prevents entry of contaminants during use of the system to fill the plurality of containers thereby facilitating sterile filling.

In some embodiments, the method comprises adjusting a space between the spacing members to correspond with the target fill volume.

In some embodiments, the method comprises opening the space between the spacing members to receive at least one container in each space before arranging the spacing members to correspond with the target fill volume.

In some embodiments, the method comprises monitoring fluid pressure during filling and terminating flow to the plurality of containers when the monitored fluid pressure reaches a target pressure.

In some embodiments, the method comprises operating a pressure source to provide the flow of fluid. The method may comprise comprising operating a negative pressure source to evacuate the plurality of containers before filling.

In some embodiments, the method comprises sealing a subset of the containers prior to filling. The method may comprise sealing a subset of the containers after filling to the target volume, adjusting the spacing members to increase expansion of the unsealed containers to enable filling to a higher target volume, and providing a flow of the fluid to the unsealed containers via the manifold until the higher target fill volume is reached.

In some embodiments, all or part of the method is automated by use of a controller comprising a processor executing instructions for controlling operation of one or more of a pumping mechanism providing the flow of fluid, a sealing mechanism for sealing the containers, and a thermal system for temperature control of the fluid.

In some embodiments, the method comprises the manifold and the plurality of containers being loaded into the system using a rack. The plurality of sealed containers may be also removed from the system using the rack.

In some embodiments, the method comprises detaching the sealed containers from the manifold after filling and sealing. The sealing step may also achieve detachment of the containers from the manifold, or detachment may comprise a separate step.

An aspect of the disclosure provides a container filled with sterile using the method of the previous aspect.

Viewed from another aspect, the present disclosure provides a method for sterile filling of containers in a filling system, comprising the steps of: arranging a plurality of the containers in the system, the plurality of containers each being in fluid communication with a manifold via a corresponding manifold limb; coupling the manifold with a flow path providing closed fluid communication between a fluid source and the plurality of containers; operating a negative pressure source to evacuate the containers to a target evacuation pressure before filling; providing a flow of the fluid to the one or more evacuated containers via the manifold until pressure in the flow path reaches a target fill pressure; and sealing the containers; wherein the target evacuation pressure is determinative of volume to which the containers are filled. The plurality of containers may comprise substantially rigid sterile containers, preferably vials.

The closed fluid flow path between the fluid source and the plurality of containers defines a barrier that prevents entry of contaminants during use of the system to fill the plurality of containers thereby facilitating sterile filling.

In some embodiments, fluid flow from the flow source to the one or more evacuated containers is flow rate controlled by use of one or more of: a pump mechanism (such as a peristaltic pump); and a flow rate restrictor.

In some embodiments, the method comprises sealing a subset of the containers prior to filling.

In some embodiments, all or part of the method is automated by use of a controller comprising a processor executing instructions for controlling operation of one or more of the negative pressure source, a sealing mechanism for sealing the containers, and a thermal system for temperature control of the fluid.

In some embodiments, the method comprises loading the manifold and the plurality of containers into the system using a rack. The rack may also be used for removing the plurality of sealed containers from the system.

In some embodiments, the method comprises detaching the sealed containers from the manifold. The sealing step may also achieve detachment of the containers from the manifold, or detachment may comprise a separate step.

An aspect of the disclosure provides a container filled with fluid using the method of the previous aspect.

Viewed from another aspect, the present disclosure provides a sterile container comprising: a container body having a first opening with a primary closure for providing user access to sterile fluid when the container is filled; and a second opening for receiving a sterile fluid to be filled into the container; wherein the second opening is configured to be sealed after filling.

In some embodiments, the container comprises a neck portion defining the second opening and optionally, a wall portion around at least part of the neck portion, the wall portion comprising an opening for providing access to the neck portion while also providing a base for standing the container. In some embodiments, part or all of the neck portion or part thereof comprises a cross-sectional shape selected from a group comprising a: circle, oval, ellipse and obround. The neck portion may be configured to be coupled with a manifold for receiving a plurality of the sterile containers to be filled.

In some embodiments, the container comprises a neck portion defining the second opening and optionally, a shield around at least part of the neck portion, the shield configured to protect at least part of the neck portion e.g. from deformation or heat. In some embodiments, the container may be co-moulded with a manifold, wherein the manifold comprises a recessed region aligned with the vial second opening and configured to receive a sealing head which deforms the recessed region, e.g. by melting, to seal the vial second opening.

In some embodiments, the primary closure comprises a removable lid such as a screw top lid or a removable cover. In some embodiments, the primary closure is not readily removable and may comprise e.g. a sealed septum, a welded lid or closure. In some embodiments, the vial comprises a secondary closure beneath the primary closure. The secondary closure may comprise e.g. a ring-pull seal, a tear-away seal such as a foil seal, or a septum which may be pierced.

Viewed from another aspect, the present disclosure provides a system for sterile filling of substantially rigid containers, the system comprising: a fluid source receiver for receiving fluid to be filled into the containers; a pumping mechanism operable to evacuate some or all of the plurality of containers prior to filling; and a sealing mechanism operable to seal the containers from the fluid source; wherein the containers are in fluid communication with a manifold having a plurality of manifold limbs and wherein the manifold is configured to provide a flow path between a fluid source received in the fluid source receiver and ones of the containers; and wherein containers are filled by providing a flow of the fluid to the one or more evacuated containers via the manifold until pressure in the flow path reaches a target pressure.

In some embodiments, the flow path between the fluid source and the plurality of containers is a closed fluid system preventing entry of contaminants during use of the system to fill the containers.

In some embodiments, the system comprises a user interface; a controller in operable communication with the user interface, wherein the controller is operable to control components of the system; and a memory storing instructions executed by a processor of the controller. The controller may be configured to control operation of components of the system such as the pumping mechanism and the sealing mechanism.

In some embodiments, the system comprises a fluid pressure sensor in the flow path, wherein controller is configured to control operation of the pumping mechanism to evacuate the containers to a target evacuation pressure correlated to a target fill volume.

In some embodiments, the containers comprise substantially rigid sterile vials. The vials may have a neck portion in fluid communication with ones of the manifold limbs of the manifold. The neck portion, or part thereof, may comprise a cross-sectional shape selected from a group comprising a circle, oval, ellipse and obround. In some embodiments, the vials each comprise a vial wall around at least part of the neck portion, the vial wall comprising an opening for receiving the sealing mechanism to seal the neck portion. The vial wall may provide a base for standing the vial when filled and detached from the manifold.

In some embodiments, the vials each comprise a neck portion, and may optionally comprise a shield around at least part of the neck portion, the shield configured to protect at least part of the neck portion from e.g. deformation and/or heat. In some embodiments, the vials may be co-moulded with a manifold, wherein the manifold comprises a recessed region aligned with the vial opening receiving fluid from the manifold, and configured to receive a sealing head which deforms the recessed region, e.g. by melting, to seal the vial opening.

In some embodiments, the vial comprises a primary closure. The primary closure may comprise e.g. a screw top, a sealed septum, a welded lid or a tear away seal. In some embodiments, the primary closure comprises a removable lid such as a screw top lid or a removable cover. In other embodiments, the primary closure may be permanently applied, such as e.g. a septum, welded lid or seal. In some embodiments, the vial comprises a secondary closure beneath the primary closure. The secondary closure may comprise e.g. a ring-pull seal, a tear-away seal such as a foil seal, or a septum which may be pierced.

In some embodiments, the system may be configured to receive more than one manifold simultaneously. The system may accommodate multiple manifolds fluidly coupled with the flow path via a hub and/or via a branched conduit.

In some embodiments, the system is configurable to fill a subset of containers in fluid communication with a manifold.

In some embodiments, the system may be configured to receive a rack carrying the plurality of containers. The rack may also be removable from the system with the sealed containers.

The mixing reservoir may be temperature controlled. Alternatively/additionally the mixing reservoir may comprise at least one thermally conductive member.

In some embodiments, the system is temperature controlled. Temperature control may occur e.g. by management of air temperature within a closable housing of the system, and/or by localised thermal conduction. Localised thermal conduction may be introduced in one or more locations within the system for achieving a desired fluid temperature, such as at one or more fluid source receivers and/or the mixing reservoir and/or tubing through which fluid flows in the system.

In some embodiments, the sealing mechanism comprises one or more of an impulse, radio frequency or heat sealing mechanism configured to seal individual ones of the containers. Alternatively/additionally the sealing mechanism may comprise a crimping mechanism configured to seal individual ones of the containers. The sealing mechanism may also detach the sealed containers from the manifold, or this may be achieved using a separate cutting/separating mechanism.

In some embodiments, the system comprises a retaining member comprising one or more spacing members defining spaces arranged to limit flexible container expansion during filling to achieve a target fill volume for at least one of a plurality of sterile flexible containers. The spacing members may be adjustable. The spacing members may comprise walls defining spaces for accommodating at least individual ones of the plurality of containers therebetween. In some embodiments, at least every second wall is moveable. Movable walls may move in concert, or they may be configured to move independently of each other.

The walls may each be of uniform thickness although that need not be the case. In some embodiments, some of the walls, such as at least every second wall or in some cases, all walls, may have non-uniform thickness across the wall so as to control the size of the space by relative movement between the container and the wall, such as by moving the container while keeping the wall stationery (or vice versa).

In some embodiments, the system comprises a controller, wherein the controller is configured to determine a required spacing between the walls to achieve the target fill volume for at least one of the plurality of flexible containers, and/or determine a different defined space to achieve a different target fill volume for at least one of the plurality of flexible containers.

In some embodiments, the system is configurable to fill containers having different type or capacity to a target volume.

In some embodiments, the system is configurable to fill containers comprising flexible containers in fluid communication with a first manifold and substantially rigid vials in communication with a second manifold, wherein the flexible containers and substantially rigid vials are filled from a common fluid source.

An aspect of the disclosure provides a container filled with fluid using the system of the previous aspect.

Viewed from another aspect, the present disclosure provides a handling rack for handling a plurality of flexible containers, the handling rack comprising one or more articulating members configured to enable orientation of the plurality of containers substantially parallel to the rack. In some embodiments, the handling rack comprises a collapsible frame.

### BRIEF DESCRIPTION OF DRAWINGS

The present invention will now be described in greater detail with reference to the accompanying drawings in which like features are represented by like numerals. It is to be understood that the embodiments shown are examples only and are not to be taken as limiting the scope of the invention as defined in the claims appended hereto. In addition the drawings are intended to be illustrative of features disclosed and are not to be taken as being drawn to scale.

FIG. 1 is an illustration of a system for sterile filling of containers according to an embodiment of the disclosure.

FIG. 2 is a schematic illustration showing elements of the system of FIG. 1.

FIG. 3a illustrates a container assembly comprising a plurality of flexible bags attached to a manifold ready for sterile filling according to embodiments of the disclosure.

FIG. 3b illustrates a handling rack holding a plurality of containers according to an embodiment of the disclosure.

FIG. 3c illustrates an example of a handling rack in which the main manifold comprises part of the handling rack.

FIG. 3d illustrates an example of a handling rack carrying flexible containers that have been folded permitting the rack and containers to lay substantially flat.

FIG. 3e is a schematic illustration of a handling rack with one or more articulating members for orienting the containers without folding or creasing the FIG. 3f shows the containers and handling rack of FIG. 3e with the containers lying almost parallel to the handling rack.

FIG. 3g is a schematic illustration of another example of a handling rack having a collapsible frame. FIG. 3h shows the collapsed frame. FIG. 4 illustrates a retaining member according to an embodiment of the disclosure.

FIG. 5 illustrates a section of the retaining member of FIG. 4 loaded with containers in the handling rack of FIG. 3b.

FIGS. 6a to 6 h are schematic illustrations demonstrating operation of movable walls to control fill volume of 5 bag containers.

FIG. 7 is an illustration of a container configured for sterile filling with a fluid according to an embodiment of the disclosure.

FIG. 8a is an illustration of a container configured for sterile filling with a fluid according to another embodiment of the disclosure having a wall portion around the neck portion. FIG. 8b is an illustration of a container configured for sterile filling with a fluid in which the primary closure is a sealed septum.

FIG. 9 is an illustration of a sterile container configured for sterile filling with a fluid and having a secondary closure according to an embodiment of the disclosure.

FIG. 10 is an illustration of a sterile container configured for sterile filling with a fluid and having a secondary closure according to another embodiment of the disclosure.

FIG. 11a illustrates a container assembly comprising a plurality vials attached to a manifold ready for sterile filling according to embodiments of the disclosure.

FIG. 11b illustrates container assemblies comprising a plurality of vials, of different vial capacities.

FIG. 12a illustrates a vial handling rack holding a plurality of containers according to an embodiment of the disclosure, ready for insertion in a retaining member. FIG. 12b shows the vial handling rack from FIG. 12a inserted into the retaining member and covered by a safety cover ready for use.

FIG. 13 illustrates a vial handling rack containing sealed vials still attached to a manifold.

FIG. 14 illustrates a filled and sealed vial after being separated from the manifold and removed from the vial handling rack in FIG. 13.

FIG. 14a illustrates an example of a vial assembly which may be used with an alternative sealing mechanism. FIG. 14b is the vial assembly of FIG. 14a viewed from the underside. FIG. 14c is sectional view showing further detail of the vial assembly of FIG. 14b. FIG. 14d is a sectional view corresponding to FIG. 14c, and showing a sealing head in position to perform sealing of a vial. FIG. 14e is an enlarged view of the area E from FIG. 14d. FIG. 14f is a schematic illustration of a vial from the vial assembly in FIGS. 14a to 14e sealed and separated from manifold. FIG. 14g is the vial of FIG. 14f viewed from the underside. FIG. 14h is a sectional view of the vial from FIG. 14f. FIG. 14i is an enlarged view of the area I in FIG. 14h which shows the sealed portion in vial 1480.

FIG. 15a is a schematic illustration of a vial which provides sterile access the interior of the vial. FIG. 15b is a sectional view of the vial of FIG. 15a. FIG. 15c is a schematic illustration of another vial which provides sterile access the interior of the vial. FIG. 15d is a sectional view of the vial of FIG. 15c.

FIGS. 16a and 16b are schematic illustrations showing arrangement of the system for filling of containers on multiple manifolds according to embodiments of the disclosure. FIG. 15 shows fluid coupling between the fluid source and the multiple manifolds via a hub; FIG. 16 shows fluid coupling between the fluid source and the multiple manifolds via a branched conduit.

FIGS. 17a,b and 18a,b illustrate examples of spacing members having non-uniform thickness; FIGS. 17a and 17b show a tapered wall thickness; FIGS. 18a and 18b show a stepped wall thickness.

FIGS. 19 and 20 are flow charts showings steps in a method of filling containers, such as flexible bag containers according to an embodiment of the disclosure.

FIG. 21 is a flow chart showing steps in a method of filling containers, such as rigid vials, according to another embodiment of the disclosure.

FIG. 22 is an illustration of a system for sterile filling of containers according to another embodiment of the disclosure.

FIG. 23 is a schematic illustration showing elements of the system of FIG. 22.

FIG. 24 is an illustration of a system for sterile filling of containers according to another embodiment of the disclosure.

### DETAILED DESCRIPTION

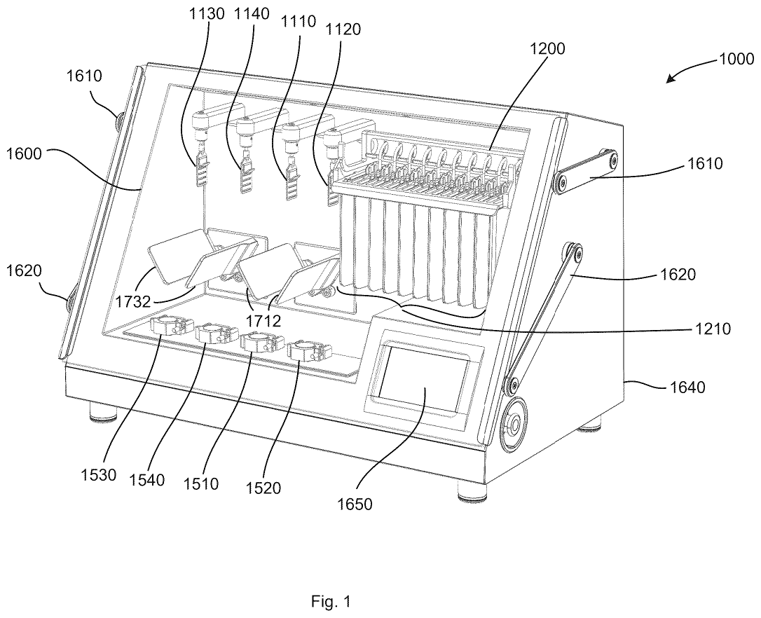

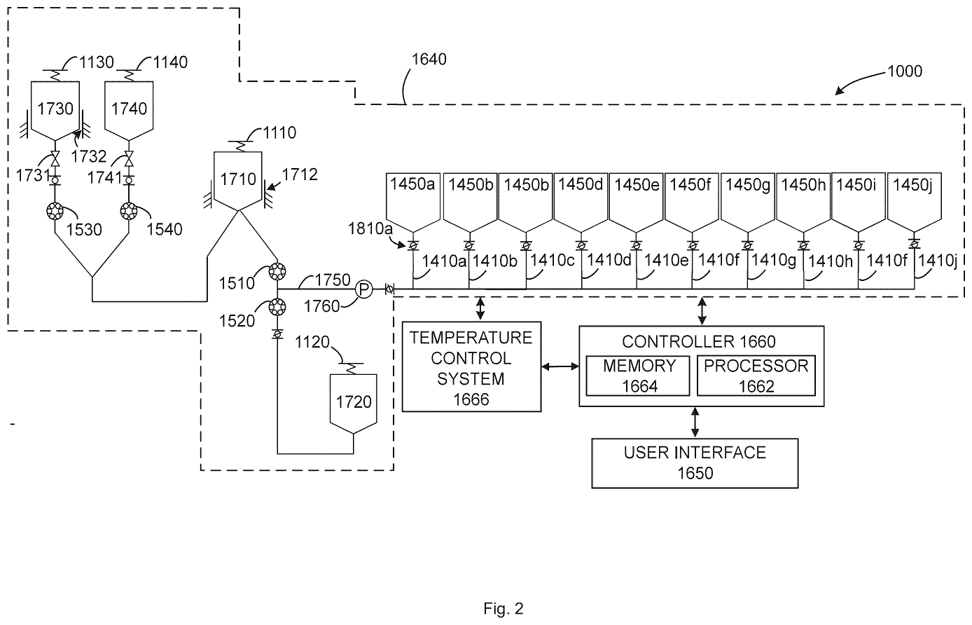

FIG. 1 is an illustration of system 1000 for sterile filling of containers according to one example. FIG. 2 is a schematic illustration showing flow control elements of the system of FIG. 1. Due to the compact nature of the system shown in FIG. 1, explanation of the system is best achieved having regard to the illustration in FIG. 1 together with the schematic diagram in FIG. 2. Advantageously, the flow path between the fluid source and the plurality of containers can provide a closed fluid system preventing entry of contaminants during use of the system to fill the plurality of containers, permitting aseptic filling without requirement for filling to be conducted in a sterile (e.g. Class A) space.

In preferred embodiments, the system 1000 is has a closable housing 1640 having a door 1600 which can be opened and closed by way of e.g. hinge pairs 1610 and/or 1620. The door 1600 may be operated manually, or control of the door may be automated by use of a controller 1660 to ensure that prior to commencement of filling, the door is closed and is not opened until the containers are sealed after completion of the filling process. When closed, temperature regulation within the housing may be achieved as described elsewhere herein. In some embodiments controller 1660 automates some or all parts of the filling process as will be further explained below.

System 1000 comprises a fluid source receiver 1110 for receiving fluid to be filled into containers. The fluid source receiver 1110 may in some embodiments comprise a hook or clip for receiving the fluid by hanging a bag containing the fluid, the bag providing a fluid source 1710 (FIG. 2). Alternatively/additionally the fluid source receiver 1110 may comprise a platform for supporting a fluid source 1710 being a container of the fluid, or the fluid source receiver may itself comprise a container into which the fluid is received. In some embodiments, the fluid source receiver may comprise a load cell for monitoring mass of contents loaded by the receiver for use by controller 1660 in monitoring fill performance and supply to the fluid source 1710.

A retaining member 1200 is configured to retain a plurality of containers into which the fluid is to be filled when the system 1000 is in use. In the embodiment shown, the retaining member 1200 comprises a plurality of spacing members and the containers are flexible containers such as flexible bags often formed from a flexible (but relatively inelastic) polymer material of the type commonly used to store therapeutic fluids. The spacing members may comprise individual walls which in FIG. 4 comprise walls 1210a to 1210t that define spaces arranged to receive 10 containers, with the volume of the space between the walls determined to limit container expansion during filling to achieve a target fill volume. Thus, the target fill volume may be less than the container capacity. In other embodiments, the spacing members comprise walls, boxes or other physical structures configured to limit expansion of the containers during filling so as to fill to a target volume. While the examples herein are explained with a single flexible container confined between a pair of spacing members, it is to be understood that two or more flexible containers could be located between a pair of spacing members and the target fill volume still controlled by reference to the separation distance between them. Good fill volume accuracy may still be achieved if the individual containers have similar elastic properties.

In some embodiments, the spacing members may be evenly spaced and fixed such that containers are filled to a single target volume determined by the extent to which the containers can expand between the spacing members. In other embodiments, the spaces can be adjusted to achieve a different the target volume. In embodiments where the spacing members comprise a wall, the space between the spacing members can be adjusted by moving some or all of the walls 1210. Alternatively/additionally, inserts may be placed in or removed from walls (or other physical structures) defining the spacing members to further constrain or increase expansion of containers received therein during filling. In some embodiments, every second wall may be movable to adjust the space into which the containers can expand during filling. In such an arrangement, every second wall may extend from a common base such that a single action (applied manually or by an actuator under control of the controller 1660) moves the movable walls in concert, relative to the stationery walls. According to some embodiments of the disclosure, the adjustable walls may be individually movable and in embodiments comprising a controller 1660, may be individually adjusted by the controller controlling individual wall actuators.

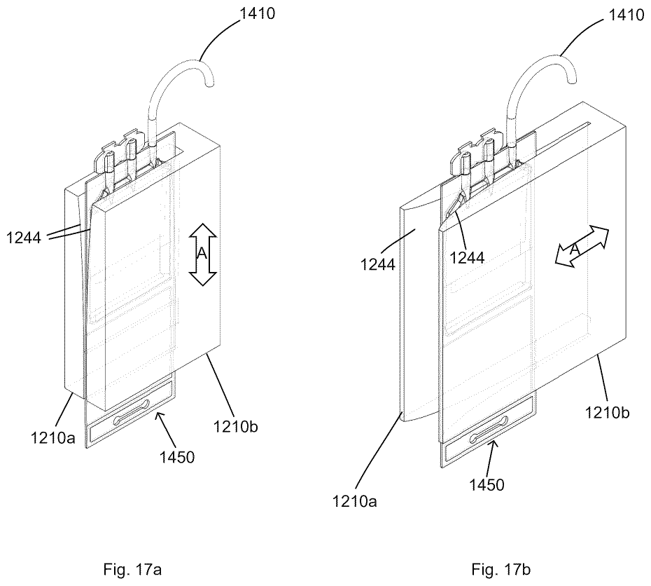

Alternatively/additionally, target fill volume may be adjusted by changing the position of the containers and spacing members relative to each other. In some embodiments, one or more of the spacing members, such as e.g. at least every second wall or every wall facing a container may comprise a non-uniform thickness. Examples of spacing members having non-uniform thickness are illustrated in FIGS. 17a,b and 18a,b which show tapered wall thickness and a stepped wall thickness respectively. Adjusting the position of the container relative to the wall enables extent of container expansion between the walls to be adjusted, thereby adjusting the target fill volume. It is to be understood that a range of different geometries may be adopted to achieve changes in the volume of space between the spacing members and hence the available volume for bag expansion between them.

By way of non-limiting example, in FIG. 17a, walls 1210a and 1210b have a tapered region 1244 that alters the vertical thickness of the walls facing flexible container 1450 and hence the space between the walls into which the container can expand when filled. By calibrating the relationship between the container position and tapering volume between the walls 1210a,b target fill volume can be controlled by relative movement between the container and the walls, as an alternative or in addition to adjusting the wall position. In FIG. 17a, vertical relative movement between the container 1450 and the walls 1210a,b in the direction indicated by arrow A can be utilised to control bag volume. In contrast, in FIG. 17b, walls 1210a and 1210b have a tapered region 1244 that alters the horizontal thickness of the walls facing container 1450. Therefore, horizontal movement between the container 1450 and the walls 1210a,b in the direction indicated by arrow A can be utilised to control bag volume. In FIG. 18a, walls 1210a and 1210b have a stepped region comprised of transition region 1240 and second thickness 1242 that alters the volume of the space between the walls into which the container can expand when filled in a vertical direction. By calibrating the relationship between the container position and stepped volume between the walls 1210a,b target fill volume can be controlled by relative movement between the container and the walls, as an alternative or in addition to adjusting the wall position. In FIG. 18a, vertical relative movement between the container 1450 and the walls 1210a,b in the direction indicated by arrow A can be utilised to control bag volume. In contrast, in FIG. 18b, walls 1210a and 1210b have a stepped region 1244 comprised of transition region 1240 and second thickness 1242 that alters the volume of the space between the walls into which the container can expand when filled in a horizontal direction. Therefore, horizontal movement between the container 1450 and the walls 1210a,b in the direction indicated by arrow A can be utilised to control bag volume.

While the spacing members shown in the figures are shown as parallel walls, it is to be understood that this is not a necessity, and non-parallel spacing members or other restrictive enclosures of various shapes may be adopted to control the extent to which containers may expand during filling. Ideally, the material of the spacing members or enclosures is sufficiently rigid to ensure adequate accuracy in the fill volume which is determined by the volume of the space into which the containers can expand. Materials having flexible or compliant properties are generally not suitable for the spacing members since they may not adequately or reliably limit container expansion in a manner that produces reliable fill volumes.

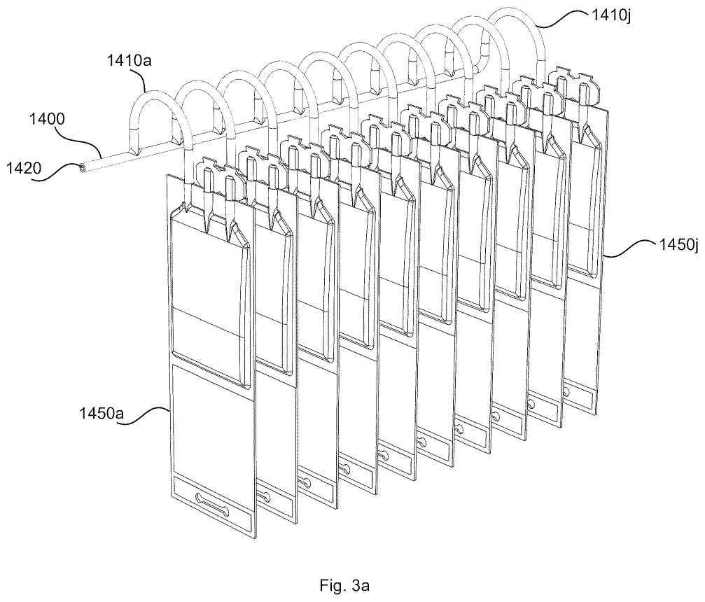

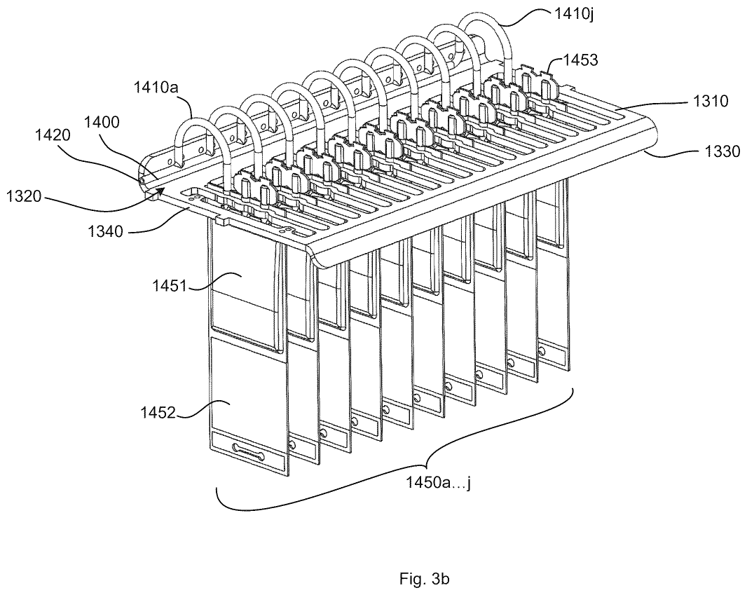

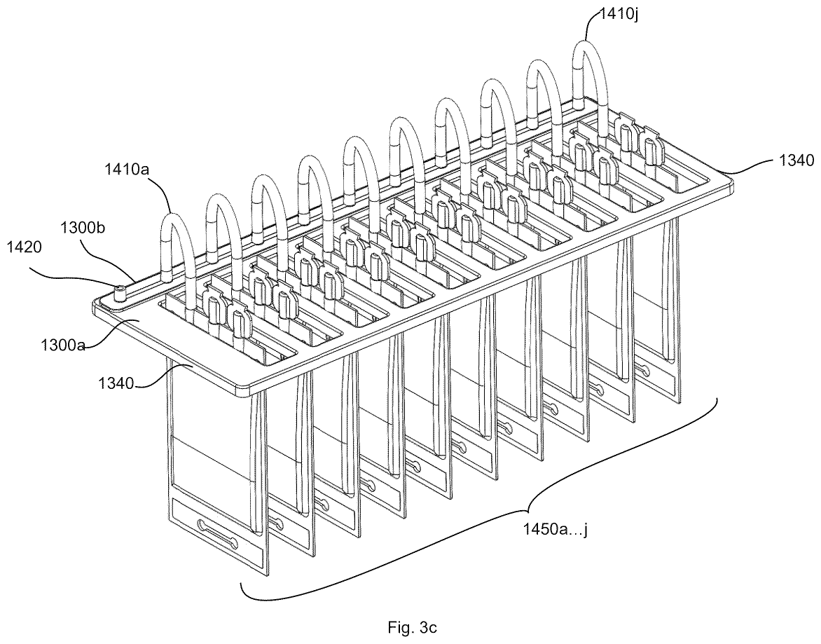

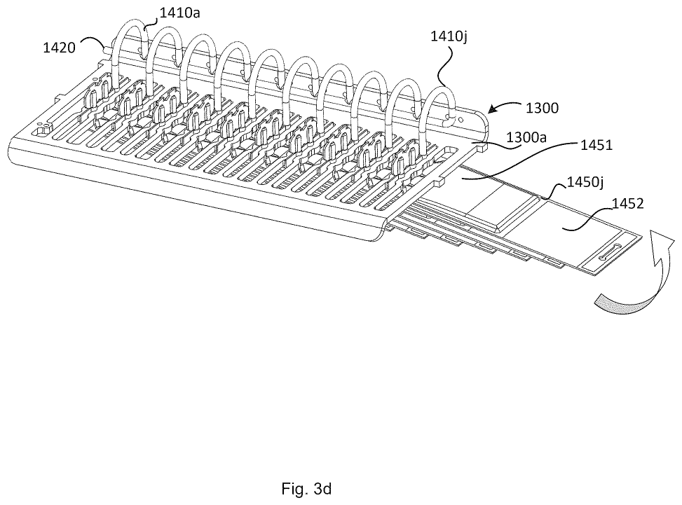

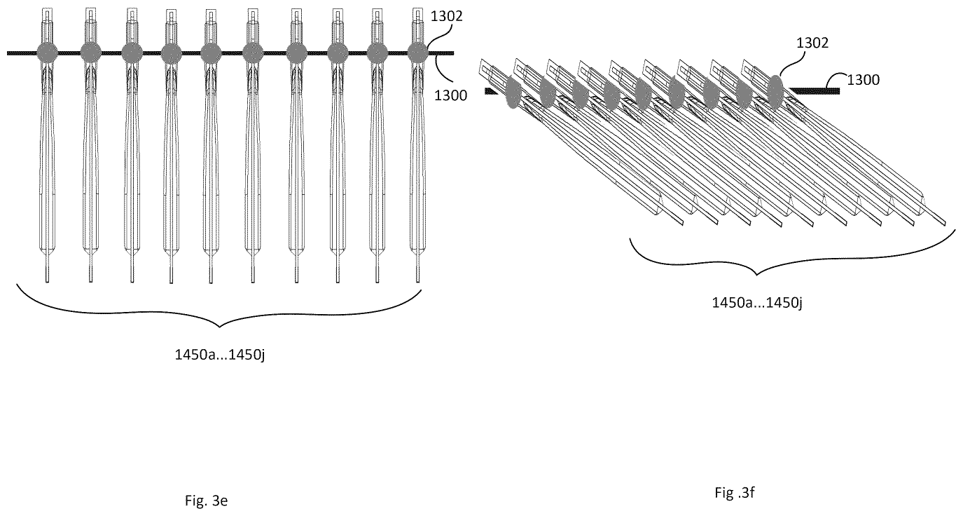

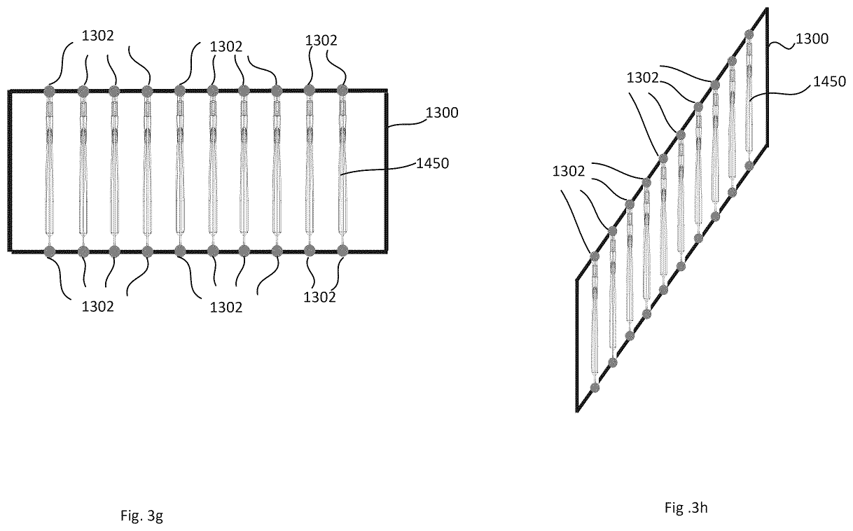

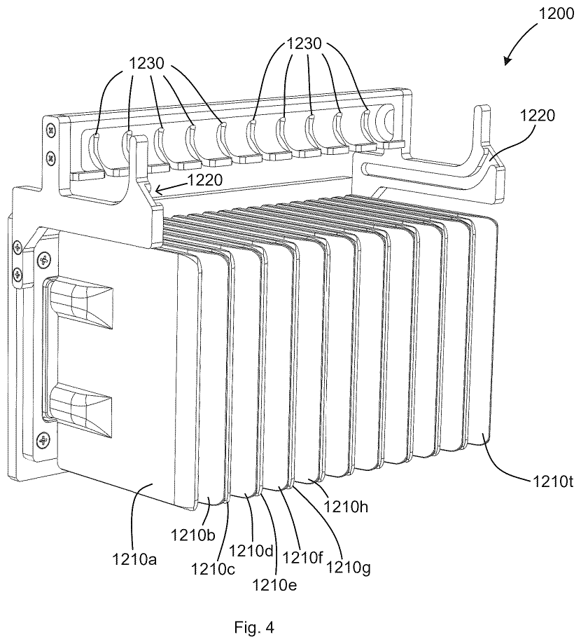

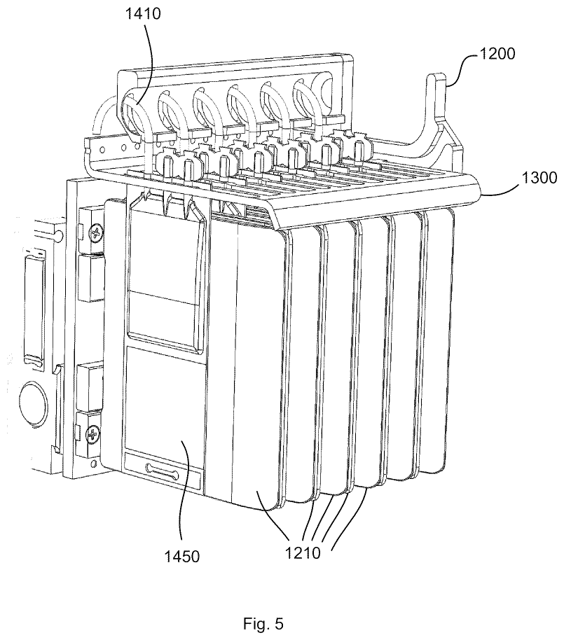

The plurality of containers 1450a to 1450j capable of being filled by system 1000 are in fluid communication with a manifold 1400 having a plurality of manifold limbs 1410a to 1410j which fluidly couple with corresponding containers 1450a to 1450j. The manifold 1400 is configured to provide a flow path 1750 between fluid source 1710 received by the fluid source receiver 1110 and the individual containers 1450a to 1450j. Containers may be coupled with the manifold 1400 using existing sterile couplings commonly used in therapeutic fluid delivery systems, and/or using sterile tube welders as are known in the art. Prior to use, the container assembly (FIG. 3a) comprising the plurality of containers coupled to the manifold may be sterilised using techniques such as irradiation (gamma and/or x-ray irradiation), ethylene-oxide (EtOH) or electron-beam sterilisation before being filled using system 1000.

For convenience, system 1000 may be configured to receive a rack carrying the plurality of containers. An example of a handling rack 1300 holding a plurality of containers is illustrated in FIG. 3b. A handling rack 1300 loaded with empty containers attached to a manifold 1400 can improve speed and ease of insertion of the containers between the spacing members, as well as speed and ease of removal of the containers once filled. In the example shown, the containers are inserted through individual slots 1310 and suspended in a spaced apart arrangement. The separation of the slots corresponds with the location of the spaces between the open spacing members or walls 1210 such that the handling rack arranges the containers conveniently for insertion between the walls. Rack 1300 also provides a support surface 1320 for the main manifold 1400 both during loading of the containers into the system 1000, and during filling. A flange or extension 1330 provides a grasping portion for the operator or automated system to handle the rack for loading in the system, and for removal of the sealed containers. A handling rack may be particularly advantageous in use of the system 1000 to achieving sterile filling of tens, hundreds or several thousand containers since throughput and cell viability can be impacted by speed of loading and unloading of containers. Also shown in FIG. 3b (and FIG. 5) is the fluid compartment 1451 of each container 1450 and a label area 1452. Such containers/bags may also comprise one or more spike ports 1453 which provide access to the bag contents after filling e.g. for patient treatment.

FIG. 3c provides another example of a handling rack 1300 for holding a plurality of containers in which the main manifold 1400 comprises part of the handling rack. In one example, the main manifold 1400 is formed between the handling rack base 1300a to which member 1300b is sealingly attached e.g. by adhesive, welding or the like, to define the main manifold 1400 flow path to fluid limbs 1410a to 1410j. The flow path may be defined by an elongate recess or channel formed in one or both of the handling rack base 1300a and the member 1300b. In another example, the main manifold 1400 may be incorporated into the handling rack 1300 by a conduit moulded into the rack base 1300a e.g. by injection moulding or the like, without application of a separate member 1300 to define the flow path. While not shown in FIG. 3c, it is to be understood that grasping flange 1330 may also be provided to assist with handling the rack, along with other features of the rack of FIG. 3b.

FIG. 3d provides an example of a handling rack 1300 carrying flexible containers 1450i to 1450j which comprise a foldable portion that allows the container to be folded. In the example shown, the flexible containers 1450a to 1450j are foldable so that they lie nearly parallel with the handling rack base 1300a. The foldable portion of the flexible container may comprise hinge, join, etching, scored line or extension portion that is predisposed to folding, relative to the rest of the container. Alternatively or additionally, the carrier 1300 may comprise a hinge or mechanical pivot to urge the flexible container to fold when actuated. Folding of the flexible containers, such as shown in FIG. 3d may provide a reduced packaging requirement for transportation and storage. Another benefit may arise from providing access to the label area 1451 of all bags simultaneously when the handling rack 1300 carrying the folded containers in inverted.

In another example, shown schematically in the side view of FIG. 3e, handling rack 1300 comprises one or more articulating members 1302 for orienting the containers relative to the rack such that they may lie nearly parallel with the rack without folding or creasing the container 1450 as shown in FIG. 3f. An articulating member may comprise a hinge or hanger that is able to pivot or rotate. In another example illustrated schematically in FIGS. 3g and 3h, the handling rack 1300 may comprise a frame that extends around the containers, wherein the frame itself has hinged corners that permit the frame to be collapsed with the containers arranged between opposing frame members. FIG. 3h shows the collapsed frame. Although FIGS. 3 and 3f show two articulating members for each container 1450, it is to be understood that the second articulating member could be omitted for each container.

FIG. 4 illustrates a retaining member 1200 according to an embodiment of the disclosure, comprising walls 1210a to 1210t in an open configuration. In the example shown, the exposed corners of the walls are rounded, and the leading edge across which the containers (in this case, fluid bags) travel when loaded are bevelled at the outer edge. This beveling forms a wider opening at the leading edge of bag insertion when the walls are open, for ease of bag loading. A channel 1220 is provided on either side of the retaining member to receive guiding edges 1340 of the handling rack. In some embodiments, the channel 1220 on retaining member 1220 may comprise an angled portion at the leading edge to guide insertion of the handling rack 1300 at an angle of e.g. 45 degrees to assist with alignment of the bag edges between the open walls. FIG. 5 is an illustration of a section of the retaining member 1200 loaded with a handling rack 1300 carrying containers (bags) installed on a manifold (main manifold not shown for simplicity), ready for filling. One can see that the bags are positioned relative to the walls such that when the walls are arranged to define the space required to achieve the target fill volume, the area into which the bags can inflate is restricted which in turn limits the fill volume to the target value.

A pumping mechanism 1500 is operable to introduce fluid into the containers 1450a to 1450j via the flow path 1750 defined by the manifold 1400 and a conduit (not shown) connecting the manifold 1400 to the fluid source 1710. In preferred embodiments the conduit is a disposable/single-use conduit that provides a sterile flow path between the fluid source 1710 and the manifold end 1420 when in use such that when the filled containers 1450 are sealed and separated from the manifold 1400 the conduit can be disposed of with the spent fluid source 1710. The pumping mechanism 1500 may comprise one or more pumps, such as peristaltic pumps 1510, 1520, 1530, 1540 which in some embodiments may operate under control of controller 1660. A sealing mechanism 1810 is operable to seal the filled containers from the fluid source. In some embodiments, the sealing mechanism 1810 may comprise a manual seal such as a plastic or metal sleeve that is crimped and mechanically cut, applied to conduit between the manifold 1400 and the fluid source 1710. Alternatively/additionally a seal may be achieved by an impulse sealer, RF sealer, heat sealer or the like. Such sealing mechanisms may be used by an operator of the system prior to removing the sealed containers from the system or they may be operated by controller 1660. In some embodiments as described in further detail below in relation to sealing of filled vials, the sealing mechanism 1810 comprises a plurality of individual sealing heads 1810 suitably located and operable to seal the containers individually, preferably by crushing and sealing the corresponding manifold limbs 1410. Sealing heads 1810 may comprise a pair of jaws comprising one stationery part and one moving part, or two moving parts, which can be operated to crush and seal the manifold limb 1410 attached to each bag 1450. In some embodiments, the sealing mechanism is also configured to cut the sealed containers from the remainder of the manifold tubing which can be discarded.

According to some embodiments of the disclosure e.g. providing 10 containers and 10 sealing heads 1810a to 1810j, these may be individually operable and in embodiments comprising a controller 1660, may be individually controllable by the controller. Accordingly, the system can be operated to fill only some of the containers on the manifold 1400 by sealing a subset of the containers before filling. For example, containers 1450i and 1450j may be sealed by operation of sealing heads 1810i and 1810j crushing and sealing manifold limbs 1410i and 1410j prior to filling such that the fluid flow path does not enter the sealed off containers 1450i and 1450j.

Controller 1660 may be operable to control components of the system 1000 such that the filling process may be largely automated. Memory 1664 stores instructions executed by a processor 1662 of the controller 1660 to control elements of the system. The system may further comprise a user interface 1650 such as a touch screen, or display and keypad or other input/output device, in operable communication with controller 1660 to receive operator inputs and display information to the operator.

In some embodiments, the controller 1660 may be configured to determine a required spacing between the spacing members to achieve a target fill volume entered into the user interface 1650 by an operator, for at least one of the plurality of containers, for some of the containers or for all of the containers. The controller may be configured to determine a different required spacing between spacing members which is required to achieve a different target fill volume for at least one other container. The controller may then control repositioning of the spacing members to achieve the required different spacing. The controller 1660 may determine the required spacing (and positioning of the spacing members) by accessing a table of data in memory 1664 which relates particular target volumes with required spacing and/or spacing member locations. In some embodiments the table of data may correspond to one or more calibration curves which may be based on empirical data obtained from a series of container filling exercises, using incremental spacing and measuring the filled volume for each increment. In embodiments where the system 1000 may be used with different container types, the data in memory 1664 may further relate target volumes and container types with required spacing and/or spacing member locations.

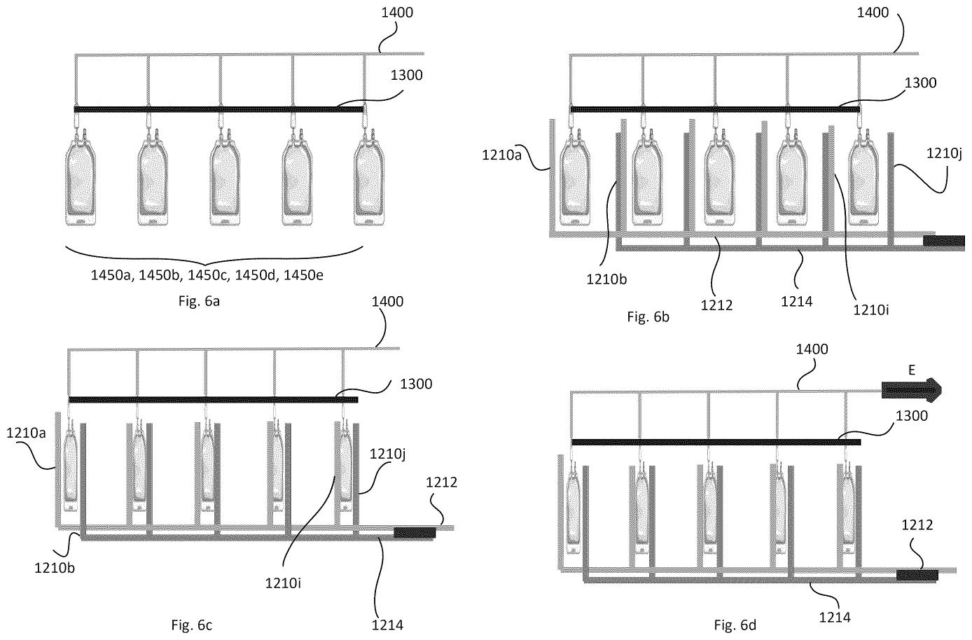

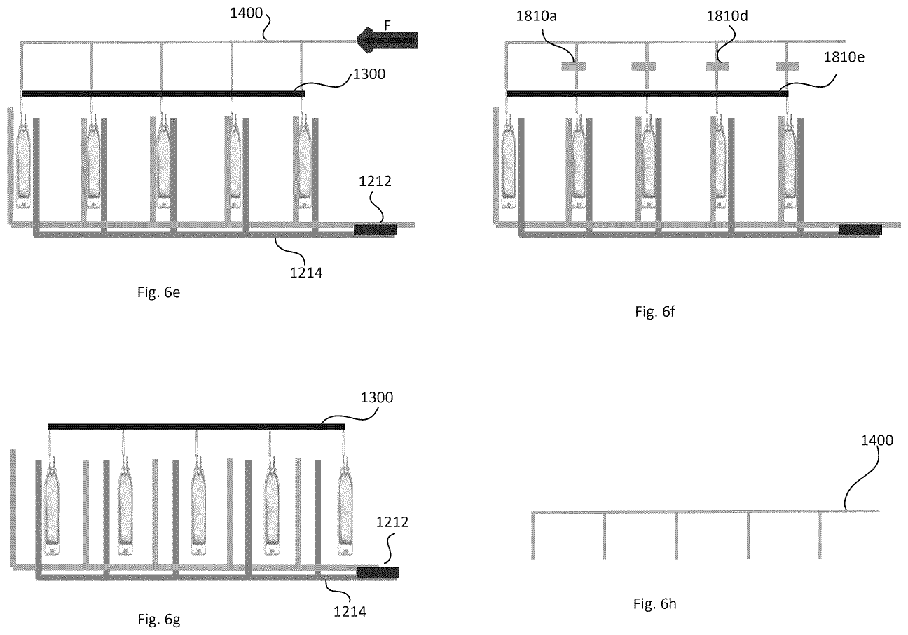

FIGS. 6a to 6 h are schematic illustrations demonstrating operation of movable walls to control target volume of 5 bag containers according to one example, however these principles may be applied in respect of fewer or more containers as would be understood by one of skill in the art. In FIG. 6a bags 1450a to 1450e are bonded to a manifold 1400 and placed in a handling rack 1300. In FIG. 6b the handling rack 1300 with the manifold 1400 and containers 1450a to 1450e is loaded into the open system 1000 by arranging the bags between pairs of walls 1210a to 1210j which have been separated to receive the bags. Every second wall 1210a,c,e,g which is connected to a first common base 1212, and every other wall 1210b,d,f,h,j is connected to a second common base 1214. In FIG. 6c the walls connected to the first common base 1212 are shifted laterally to close the space between the pairs of walls thereby limiting the space into which the bags can expand as shown. In FIG. 6d, a vacuum is applied via manifold 1400 to remove air from the bags (represented by arrow E) and in FIG. 6e, fluid is introduced through the manifold (represented by arrow F) to the predetermined pressure level. In FIG. 6f the containers are sealed, and preferably cut by application of sealing heads 1810a to 1810e. In FIG. 6g the walls are separated by translation of the first common base 1212 laterally in the opposite direction to FIG. 6c and the filled bags are removed in the handling rack 1300 for inspection, labelling, cryogenic freezing and distribution. FIG. 6h shows the spent manifold which is removed from the system 1000 and discarded with the remainder of the conduit forming the fluid flow path 1750.

In a semi- or fully-automated filling system 1000 according to embodiments of the disclosure, the movable spacing elements may be positionally controllable by e.g. an eccentric drive which is operated from a servo and worm drive or other mechanical configuration as would be understood by one of skill in the art to achieve precisely controlled positioning for accurate filling of the bags to the target volume. Operation of the servo and worm drive is under control of controller 1660. To adjust the target fill volume, the space between the spacing members is increased or decreased according to a correlation to the gap size and fill volume required for the bag type being used, as stored in memory 1664 of controller 1660.

In some embodiments, controller 1660 is configured to control operation of the pumping mechanism 1500 to achieve filling of the containers to the target fill volume. The pumping mechanism 1500 may comprise individual pump elements such as pump elements 1510, 1520, 1530, 1540 shown in FIGS. 1 and 2. In the embodiment illustrated the pump elements comprise peristaltic pumps however it is to be understood that alternative pump systems may be adopted including, in some cases, gravity fed pump systems. In the embodiment illustrated, pumping mechanism 1500 comprises fluid source pump 1510 which is operable to provide a flow of fluid from fluid source 1710 to the plurality of containers 1450a to 1450j via flow path 1750. In some embodiments, a valve to atmosphere (not shown) may be provided between the fluid source 1710 and fluid source pump 1510, and the fluid source pump may be used to generate a negative pressure to evacuate the containers 1450a to 1450j prior to filling. However, it may be preferred that a separate evacuation pump 1520 is provided for this purpose negating the need for the valve to atmosphere. In addition to removing air from containers on the manifold 1400, evacuation pump 1520 may be operated to perform leak detection on the containers prior to filling, and to confirm integrity of the fluid flow path. Evacuation pump 1520 may or may not be provided with a waste reservoir 1720.

The system 1000 may further comprise a fluid pressure sensor 1760 in the flow path 1750, wherein controller 1660 is configured to control operation of the pumping mechanism 1500 (such as fluid source pump 1510) to stop filling when the fluid pressure sensor 1760 determines a target pressure has been reached. Pressure sensor 1760 provides an additional level of safety by ensuring that the bag is expanded and not sticking or bunching/gathering during the fill process preventing inflation to accommodate the full target volume. The target pressure may be stored in memory in a data table which relates particular fill volumes and bag types with target pressure. In some embodiments, the data table may correspond to one or more calibration curves which may be based on empirical data obtained from a series of container filling exercises, using incremental container fills at known volumes to determine the corresponding pressures at those increments for certain container types (e.g. size, shape, material etc). For containers comprising flexible bags, the bag size/capacity can range from millilitres to litres and thousands of litres in some cases. In embodiments not incorporating automated control of the pumping mechanism, a user can monitor the pressure by display of the pressure sensor values on user interface 1650 and manually stop operation of the pumping mechanism when the target pressure has been reached. As an alternative to monitoring pressure, the controller 1660 (or a system operator) may use a timer to determine when to stop operation of the fluid source pump 1510.

Embodiments of the present disclosure may be utilised for sterile filling of fluids of a broad ranges of types into containers for a wide variety of applications. In many cases, the fluid may contain cell product. Fluids containing cell product are high value and are also sensitive to temperature. Thus, the system may be temperature controlled such that particularly when the system housing is closed, not only does the system 1000 provide a filling environment that is aseptic, it can also be thermally controlled. Ideally this is by use of a temperature control system 1666 which typically provides thermostatically controlled refrigeration using techniques known to those of skill in the art. Ideally, operation of the temperature control system 1666 is under control of controller 1660 and the required temperature can be selected by an operator through user interface 1650. Typically operational temperatures for cell products would be in a range of about 2 deg C. to about 8 deg C., such as about 4 deg C.

It is relevant to note that the container filling system according to various aspects of the present disclosure may require only a single fluid source (e.g. fluid source 1710) and a single pumping mechanism (e.g. fluid source pump 1510) to supply a controlled flow of fluid to the fluid flow path 1750 for filling into the containers on manifold 1400. As conveyed above, an evacuation pump 1520 may be desirable which, in some cases, may be coupled with a waste reservoir 1720 which is retained in system 1000 by a receiver 1120.

In some applications, it may also be desirable to incorporate into system 1000 elements that can achieve formulation of a fluid, such as a cell product composition, which may then be filled into the containers. Thus, also shown in FIGS. 1 and 2 are a cell product receiver 1130 for receiving a bag containing cell product 1730 and a cryopreservative receiver 1140 for receiving a bag containing cryopreservative 1740. Pinch valves 1731 and 1741 may be provided to control flows of the cell product and cryopreservative respectively into the respective pumps 1530 and 1540 which are operated, typically under control of controller 1660, to release quantities of the cell product and cryopreservative into the bag comprising the flow source 1710 from which the containers are subsequently filled with the mixed cell product composition. In this respect the bag attached to receiver 1110 becomes a mixing reservoir. Pinch valves 1731, 1741 and pumps 1530, 1540 control flow rates to reduce shear and mitigate risk of damage to cells as they are exposed to the cryopreservative. The controller may be programmed to mix the required quantity of cell product and cryopreservative over a period of about e.g. 5 to 15 mins such that impacts of exothermic energy released during the mixing process can be addressed by the temperature controlled environment inside the closed housing.

FIGS. 1 and 2 show paddle mixers 1732 for mixing the cell product 1730 and paddle mixers 1712 for ensuring homogeneity in the cell product and/or mixing the cell product composition comprising the fluid source 1710. In some embodiments, the mixing paddles are fabricated from a material that is thermally conductive, such as aluminium, and that enables the paddles to become temperature soaked according to the thermal control within the closed instrument such that use of the paddles to gently agitate the contents of the bags attached to the receivers 1130 and 1110 imparts thermal stability to the contents. In some embodiments the aluminium mixing paddles may be of e.g., approx. 5-10 mm in thickness. Alternatively/additionally, the mixing paddles 1732 and 1712 may be temperature controlled e.g. by containing a cooling channel that is coupled to the system cooler, or a secondary cooler, thereby providing temperature control over the mixing reservoir and/or the cell product through the mixing paddles. Alternatively/additionally, the mixing reservoir may be provided within a separate temperature controlled zone within the instrument. Thus, temperature control may occur e.g. by management of air temperature within housing 1640, and/or by localised thermal conduction. Localised thermal conduction may be introduced in one or more locations within the system for achieving a desired fluid temperature, such as at one or more fluid source receivers and/or mixing paddles and/or tubing through which fluid flows in the system. While the filling system according to embodiments of the disclosure has been described in the context of sterile filling of containers comprising flexible bags, it is also contemplated that embodiments of the disclosure may be used for sterile filling of containers comprising vials, such as rigid vials. Therapeutic fluids are often filled into smaller vials for quality control (QC) checking of batches of fluids filled into larger volume containers. Vials may also be used for cell banking, precursor and/or intermediate materials such as viral vectors and for therapeutic applications.

Prior art cell therapy packaging/filing approaches have sought to address the requirement for filling of QC and other vials by opening, filing and re-closing the screw top lid of the vial. However this approach risks compromising the sterility of the sample and in turn the viability of the contents, especially in the case of cell products and can produce inconsistencies with respect to the viability and quality of the batch of product the QC vial is intended to represent. The present disclosure provides a novel approach to aseptic filling of vials involving a novel vial design comprising an opening, separate from the screw top lid, through which fluid can be aseptically filled into the vial.

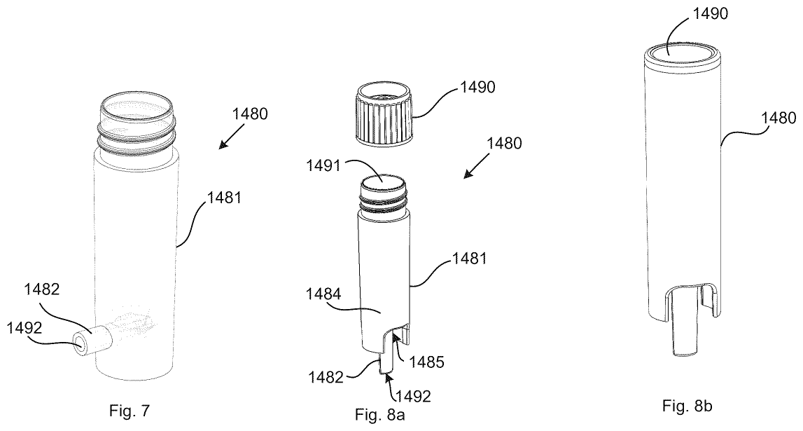

Non-limiting examples of sterile containers comprising vials according to embodiments of the disclosure are disclosed herein such as in FIGS. 7 to 15d. In one example, sterile container 1480 comprises a container body 1481 having a first opening 1491 with a primary closure 1490 for providing user access to sterile fluid when the container is filled. A second opening 1492 receives a sterile fluid to be filled into the container and is configured to be sealed after filling. This arrangement enables sterile filling of the container without disrupting the primary closure 1490 which provides later access to the sterile contents of the vial. The second opening may be defined by a neck portion 1482 although the neck portion may, in some examples be very short or negligible, such as a neck portion formed only by the thickness of the vial material at the second opening 1492.

In some embodiments, a wall portion 1484 is provided around at least part of the neck portion 1482, as shown in FIGS. 8-10. The wall comprises a notch or opening 1485 for providing access the neck portion while also providing a base for standing the container. Access to the neck portion through notch 1485 enables access to the neck portion to be sealed e.g. by a sealing mechanism 1800 which may have sealing heads as described elsewhere herein in the context of system 1000. Advantageously, wall portion 1485 may provide a base around the sealed neck portion of the sealed vial 1480 so that the filled container has overall appearance and/or dimensions that may be compatible with existing operators, systems and workflow processes.

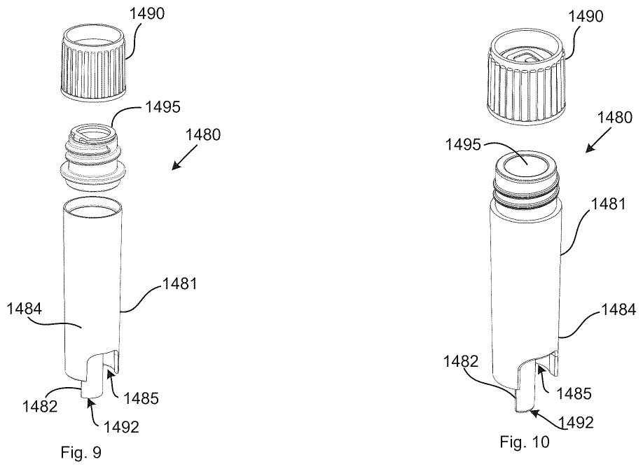

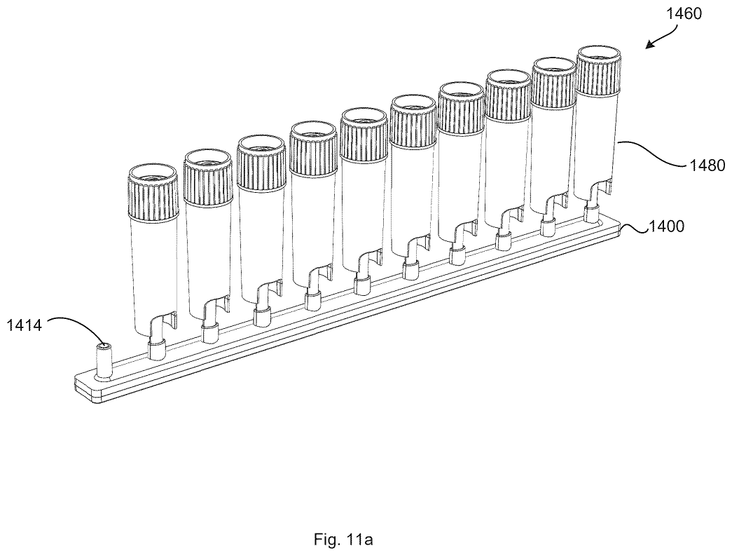

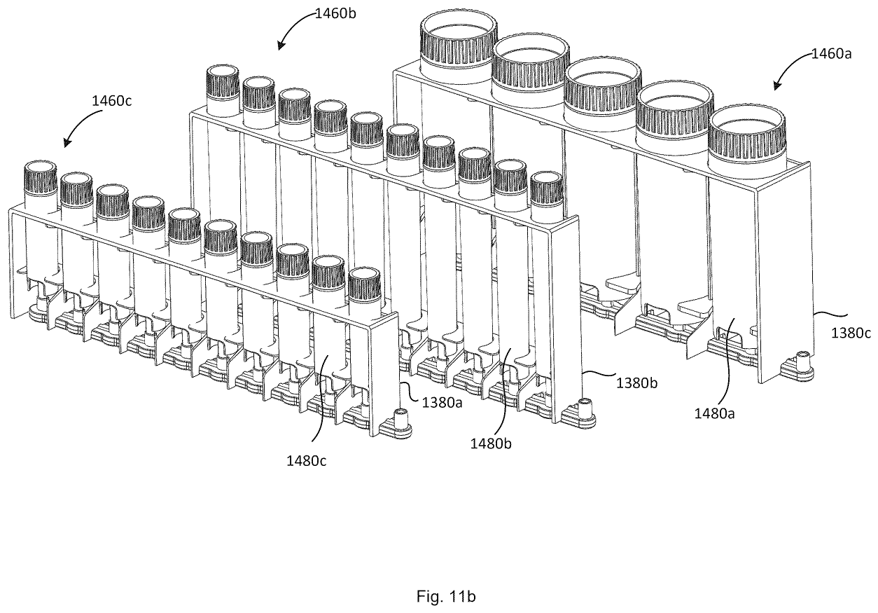

The vial body 1481 defines the space into which the fluid is filled. The second opening 1492 and neck portion 1482 through which fluid is aseptically filled into the vial body are separate from primary closure 1490. As in the case of the containers 1450 described previously, the neck portion 1482 is configured to be coupled by bonding or other means with ones of manifold limbs 1410 such that a plurality of vials can be provided on a manifold 1400 as illustrated in FIG. 11. A primary closure 1490 in the form of a screw top lid is provided as in FIG. 8a. A screw top lid may be provided as the primary closure 1490 for user familiarity however it is to be understood that the primary closure may be replaced with other closures such as friction fit and membrane closures, such as the sealed septum closure shown in FIG. 8b. In the embodiment shown in FIGS. 7 and 8, there is no secondary closure therefore it is critical that the primary closure remain sealed until access to the filled vial contents is required, to ensure the contents remain aseptic. In some embodiments, primary closure integrity may be observed by incorporating tamper-evident lids or seals to ensure sterility of contents used on patients. In some embodiments, the primary closure is a seal or septum, which may be welded or sealed over the vial first opening 1942 so that it cannot loosen or become compromised before use. A dust cap or the like may also be provided. Alternatively/additionally, a secondary closure may be provided as described with reference to FIGS. 8 and 9. Wall portion 1484 beneficially provides a base for standing the vial when filled and detached from the manifold.

In some embodiments, the neck portion 1482 or a portion thereof may be oval in cross section to assist with crushing and sealing by the sealing mechanism 1800 although this cross-sectional shape may be replaced with others for manufacturing or operational reasons. In the embodiment shown in FIG. 8, the neck portion provides access for sterile filling of the vial from the opposite end to the primary opening. However it is to be understood that the vial is not to be limited to such an arrangement, and that the neck portion used for vial filling may be provided through a side wall or other part of the vial body 1481 that enables the primary closure 1490 to remain sealed during filling. When the neck portion is provided in a side wall, the wall portion may be omitted since the vial body may be of a more conventional shape with a flat base for standing up of the vial as shown in FIG. 7.

In some embodiments, in addition to the removable primary closure 1490, vial 1400 may comprise a secondary closure 1495 beneath the primary closure to provide a safeguard against accidental opening or loosening of the primary closure. The secondary closure 1495 may comprise e.g. ring-pull seal as shown in FIG. 9. Alternatively, the secondary closure 1495 may comprise a membrane such as a tear-away foil membrane or a rubber or polymer septum as illustrated in FIG. 10 that can be pierced by an operator to gain access to the contents e.g. by piercing with a needle and drawing contents up into a syringe.

In a manner similar to previously described with respect to flexible bag containers, the manifold 1400 is coupled with a flow path 1750 provided by a conduit (not shown) between fluid source 1720 received by the fluid source receiver 1110 and the manifold 1400 which is in fluid communication with the individual vials 1480. In some embodiments the conduit is a disposable/single-use conduit that provides a sterile flow path between the fluid source 1710 and the manifold when in use such that when the filled vials 1480 are sealed and separated from the manifold 1400 the conduit can be disposed of with the spent fluid source 1710. Vials 1480 may be coupled with the manifold 1400 using couplings commonly used in therapeutic fluid delivery systems, and/or using sterile tube welders as are known in the art. Prior to use, the vial assembly 1460 (FIG. 11) comprising the plurality of containers coupled to the manifold may be sterilised using techniques such as gamma (irradiation), ethylene-oxide (EtOH) or electron-beam sterilisation before being filled using system 1000.

FIG. 11a provides another example of a vial assembly 1460 in which vials 1480 are co-moulded together with the manifold 1400 rather than bonded to a separate manifold 1400 as in FIG. 11. Co-moulding of the vials 1480 with the manifold 1400 may be performed by injection moulding or other suitable techniques and may reduce the number of production steps which may save costs. While FIGS. 11 and 11a show vial assemblies 1460 each comprising 10 vials, it is to be understood that this is illustrative only. The vial assembly may comprise fewer or more vials, as would be understood by one of skill in the art. By way of non-limiting example, a vial assembly may comprise e.g. 10, 20, 30, 50, 100, 1000, 2000, or even 10,000 vials. Furthermore, the vials 1480 of vial assembly 1460 may be of a size and/or volume that may be selected according to different requirements. FIG. 11c is a schematic illustration showing examples of vial assemblies 1460a, 1460b and 1460c in a handling rack 1380a, 1380b, 1380c, which each comprise vials of different volumes. In one non-limiting example, vial assembly 1460a comprises vials 1480a of approximately 1.8 mL, vial assembly 1460b comprises vials 1480b of approximately 5 mL and vial assembly 1460c comprises vials 1480c of approximately 50 mL.

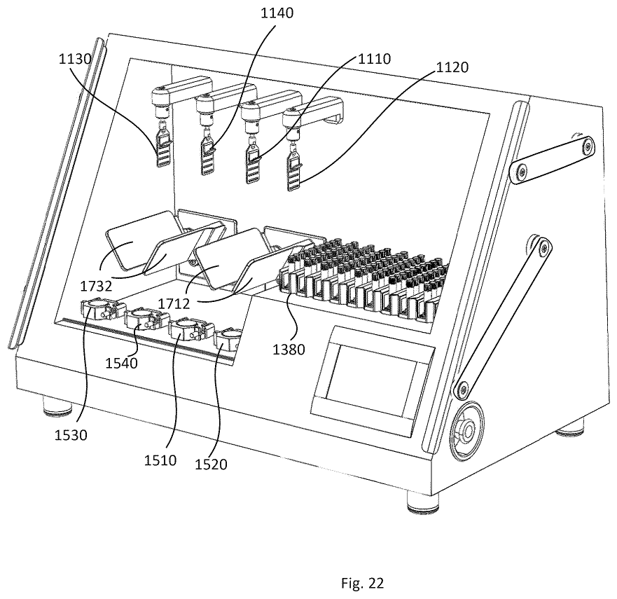

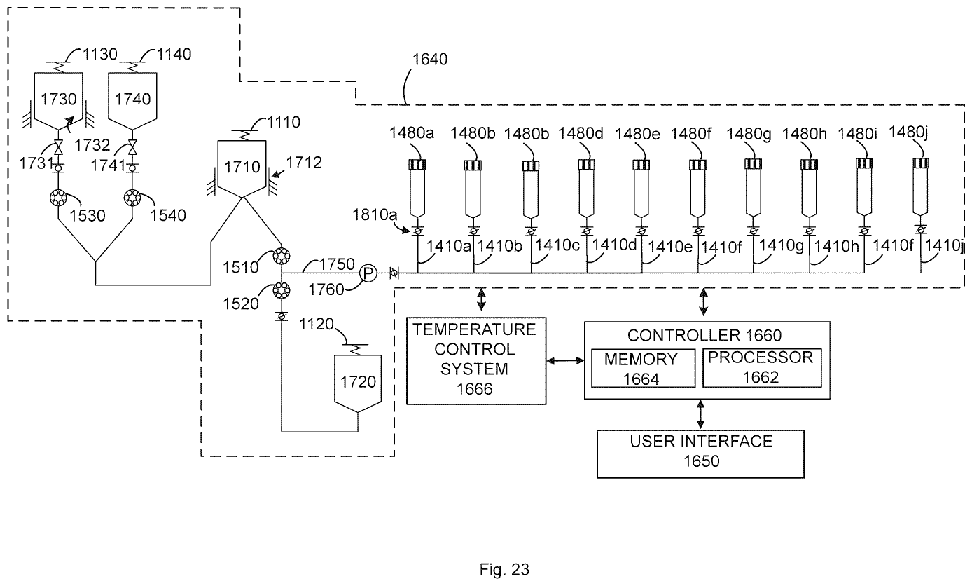

FIG. 22 is an illustration of system 4000 for sterile filling of containers comprising vials, according to one example which is similar to the system of FIG. 1 as previously described. FIG. 23 is a schematic illustration showing flow control elements of the system of FIG. 22. Due to the compact nature of the system shown in FIG. 22, explanation of the system is best achieved having regard to the illustration in FIG. 22 together with the schematic diagram in FIG. 23.

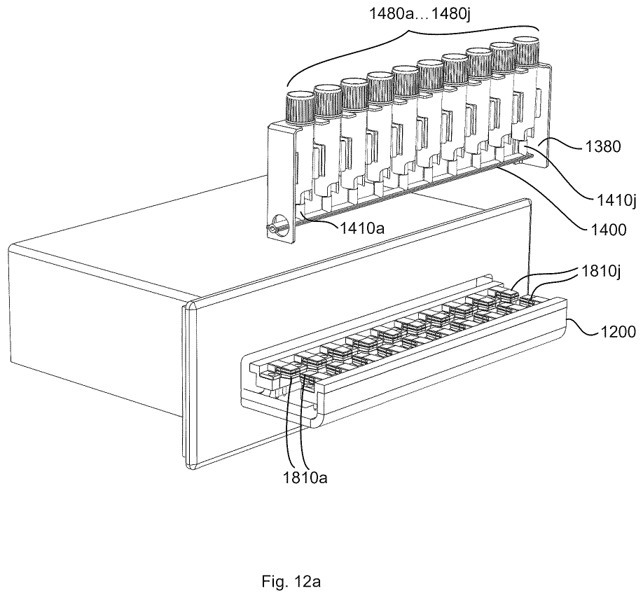

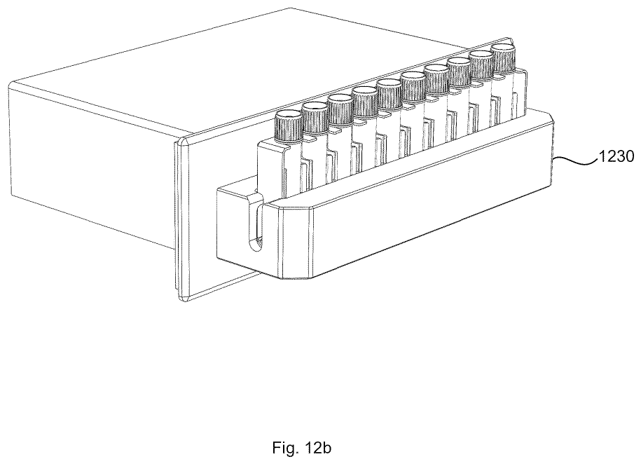

For convenience, system 4000 may be configured to receive one or more racks 1380 carrying a plurality of vials 1480, an example of which is shown in FIGS. 11b and 12a, loaded with e.g. 10 empty vials connected by a manifold 1400. The 100 vials shown in FIG. 22 may be loaded into system 4000 in 10 individual racks 1380 containing e.g. 10 vials each, or using 2 racks of 50 vials each, or using racks containing other quantities of vials. In the example shown in FIG. 12a, the vials 1480 are inserted into individual slots in the rack 1380 which retain the vials in place. The separation of the slots retains the individual vials 1480 with manifold limbs 1410 attached to the vials in alignment with an opening between sealing head pairs 1810 in the retaining member 1200 of system 4000 into which the rack/s 1380 are inserted. In the example shown in FIG. 12a, the vials may be loaded into the retaining member 1200 of the system 1000 by downward movement of the vial handling rack 1380. Preferably, the manifold with the containers would be provided connected to and sterilised with the single use conduit. Alternatively, prior to commencement of filling, the main manifold 1400 may be connected by sterile connection at end 1414 with a single use conduit (not shown for simplicity) providing a fluid flow path 1750 with the fluid source 1710. In some applications, subsequent fills may be achieved by removal of the spent manifold after filling/sealing of containers, after which a fresh manifold with empty containers can be attached to the conduit by sterile connection for filling with fluid from the same fluid source. In this context, the single use conduit is used only to fill containers from a single fluid source before it is disposed of. Elements of the system for sterile filling of the vials are shown in FIG. 23 which uses the same numbering convention as fluid flow elements described in relation to FIG. 2. FIG. 12b shows the vial handling rack 1380 installed in the receiving member 1200 with a safety cover 1230 applied to avoid accidental contact with the sealing heads 1810 during operation although a safety cover need not be applied. In the example shown, safety cover 1230 can be applied by an operator or by automation over the retaining member 1200 in a downward direction, and removed upwardly to allow removal of the vial carrying rack with the filled vials. In other embodiments, the vial rack 1350 may be inserted and removed from the retaining member 1200 with the safety cover 1230 in place.

To fill the vials, pumping mechanism 1500 may be operated to evacuate the vials 1480 to a target evacuation pressure that is calibrated to the required target fill volume for the vial. In some embodiments, the evacuation pressure is pre-programmed into the controller 1660 and stored a data table in memory 1664 for automated control of the pumping mechanism. In some embodiments, the data table may correspond to one or more calibration curves which may be based on empirical data obtained from a series of vial filling exercises, using incremental evacuation pressures and measuring the resulting fill at those increments for certain container types (e.g. size, shape, material etc). For containers comprising rigid vials, capacity can range from e.g. less than 0.5 mL to greater than 50 mL.

In some embodiments, a valve to atmosphere with sterile filter (not shown) may be provided between the fluid source 1710 and fluid source pump 1510, and the fluid source pump may be used to generate a negative pressure to evacuate the vials 1480a to 1480j. However, it may be preferred that a separate evacuation pump 1520 (and optionally waste reservoir 1720) is provided for this purpose negating the need for the valve to atmosphere. Once the target evacuation pressure has been reached, as may be determined by pressure sensor 1760, pump 1510 is operated to permit flow of fluid from fluid source 1710 into the vials 1480. Thus, the system 1000 is operable to fill the vials to the target fill volume by controlling the evacuation pressure in the vials prior to releasing the fluid. Active pumping need not be required since the vacuum created in the flow path causes fluid to be drawn into the vials as the pressure in the flow path equalises. In some embodiments it may be desirable to draw pressure into the vials to a target fill pressure to maintain a degree of evacuation/negative pressure or residual positive pressure within the vials when sealed as may be monitored using pressure sensor 1760. Flow rate and/or time to fill may be controlled by modifying the length of the flow path 1750 and/or providing a restriction in the flow path and/or by use of pumps 1510 and/or 1520 to reduce shear forces that could damage cells or other shear-sensitive materials in the fluid.

As described previously for filling of containers comprising flexible bags, the system may be temperature controlled by operation of the temperature control system 1666 under control of controller 1660. The required temperature can be selected by an operator through user interface 1650. Paddle mixers 1732 may also be provided for mixing the cell product 1730 and paddle mixers 1712 may be provided for ensuring homogeneity in the cell product and/or mixing the cell product composition comprising the fluid source 1710. The Paddle mixers may also provide thermal control as described previously.

Sealing heads 1810 to 1810j may comprise a pair of jaws comprising one stationery part and one moving part, or two moving parts, which can be operated to crush and seal the neck portion 1482 and/or manifold limb 1410 of each container vial 1480a to 1480j. A seal may be achieved by impulse, RF, heat, crimping or the like. Such sealing mechanisms may be used by an operator of the system prior to removing the filled vials from the system 1000. In some embodiments, the sealing mechanism may also be configured to cut the filled vials from the remainder of the manifold tubing. In some embodiments, pairs of sealing heads 1801a to 1810j access the neck portion 1482 and/or manifold limb for each vial through the opening 1485 in the wall portion which is aligned with the moving part of the sealing head 1810 by vial handling rack 1380.

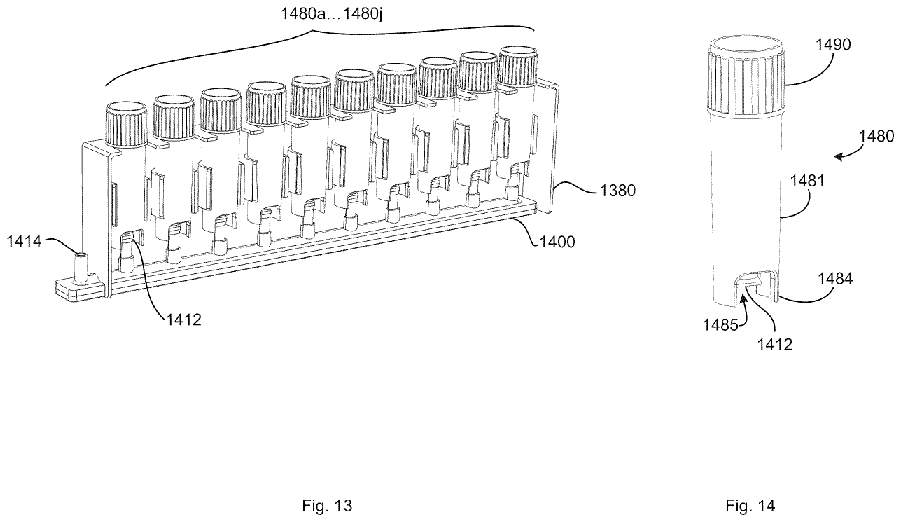

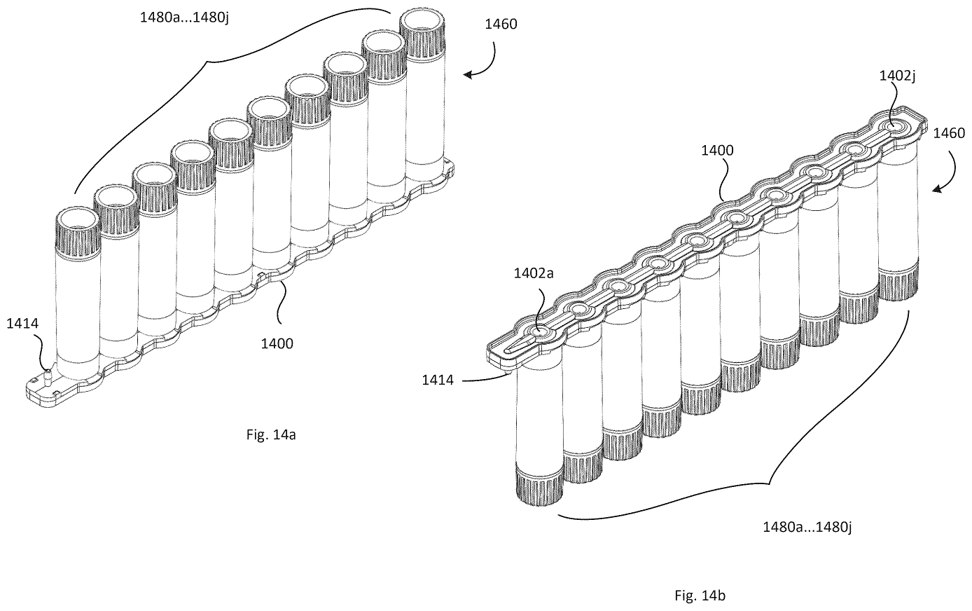

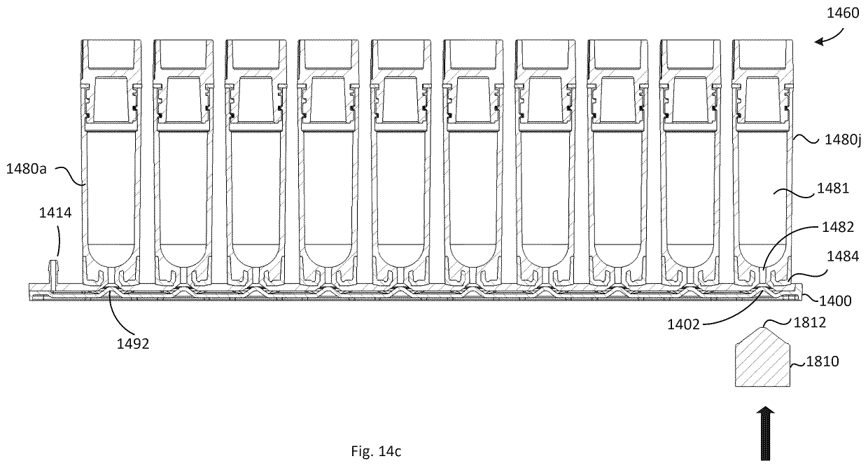

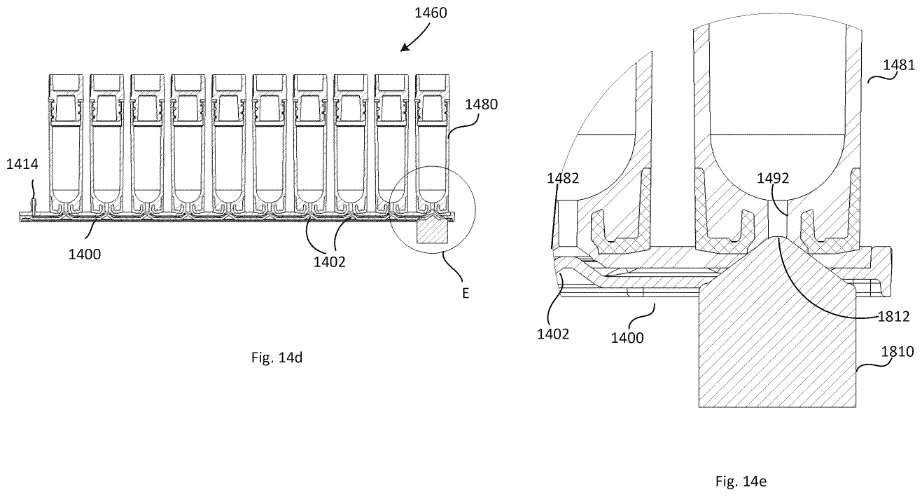

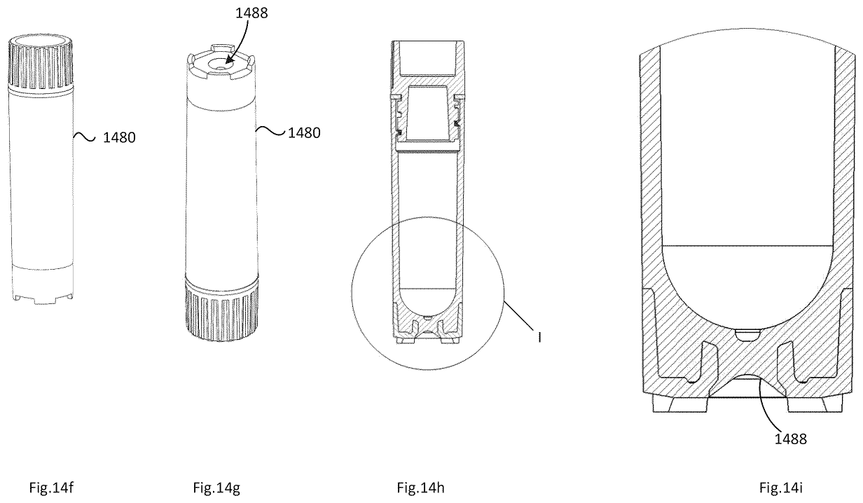

The sealing heads 1810 may be individually operable and in embodiments comprising a controller 1660, may be individually controllable by the controller. Accordingly, the system can be operated to fill only some of the vials 1480 on the manifold 1400 by sealing a subset of the manifold limbs 1410 before filling. For example, vials 1480i and 1480j may be sealed by operation of sealing heads 1810i and 1810j crushing and sealing manifold limbs 1410i and 1410j prior to filling such that the fluid flow path does not enter the sealed off vials 1450i and 1450j. An example of a vial handling rack 1380 containing sealed vials 1480 still attached to the manifold 1400 is illustrated in FIG. 13. Seal 1412 (marked only for vial 1480a for simplicity) may be formed by impulse, heat, friction or the like as may be achieved by sealing heads 1810. Manifold 1400 has been cut from the conduit forming the fluid flow path at end 1414 in FIG. 13. FIG. 14 which illustrates a filled and sealed vial after being sealed and cut from the manifold and removed from the vial handling rack 1380.

Another example of a vial assembly 1460 which may be used with an alternative sealing mechanism is provided in the schematic illustration of FIGS. 14a and 14b which show the vial assembly from the top, and the underside, respectively. In this example, vials 1480 are co-moulded with manifold 1400 in such a way that sealing and separating of the vials may be achieved from the underside of the vial assembly 1460. The sectional view of FIG. 14c shows further detail of the structure of the co-moulded vial assembly which permits sealing of vials 1480 (and optionally, separation from the manifold 1400) with movement of a sealing head 1810 towards and in alignment with the neck portion 1482 and second opening 1492 of vial 1408, rather movement of the sealing head 1810 laterally as in FIG. 12a. A shield 1484 is provided around neck portion 1482 for protection e.g. to thermally shield vial body 1481 and contents of the vial 1480 from the heat applied by sealing head 1810 and/or to protect from deformation. In some embodiments, the co-moulded vial assembly may be manufactured from a polymer material that is suitable for the use case for the vials, whereas the shield 1484 comprises a material that has a higher melting temperature. The shield 1484 may be an over-moulded component of the vial assembly 1460.

In one example, after filing of the vials is complete, sealing head 1810 moves toward second opening 1492, advancing sealing head tip 1812 into recess 1402 where heat is applied to melt the manifold material into the second opening 1492 to form a sealed closure. Shield 1484 limits heat transfer from sealing head 1810 and provides a reaction surface for the sealing head tip 1812 which in some embodiments, enables the sealing head to both seal and separate the vial 1480 from the manifold 1400. In another example, sealing head 1812 may apply pressure to deform the manifold recess to seal the second opening 1492 without heat, and the shield 1484 protects the neck portion 1482 from deformation due to pressure and/or temperature applied by the sealing head 1810. FIG. 14d is a sectional view of FIG. 14c, showing the sealing head tip 1812 in position to perform sealing of the vial 1480. FIG. 14e is an enlarged view of the area E in FIG. 14d which shows location of sealing head tip 1812 relative to the manifold recess 1402 and vial opening 1482, for sealing of the vial 1480. FIG. 14f is a schematic illustration of a vial 1480 from FIGS. 14a to 14e sealed and separated from manifold 1400. FIG. 14g shows the underside of the vial 1480 from FIG. 14f showing the sealed portion 1488. FIG. 14h is a sectional view of the vial 1480 from FIG. 14f. FIG. 14i is an enlarged view of the area I in FIG. 14h which shows the sealed portion 1488 in vial 1480. The vial example of FIGS. 14a to 14i may provide advantages in that the neck portion 1482 is shortened. This provides a compact design and may reduce fluid wastage. Owing to its simplicity, this arrangement may also provide improvements in cleanability.

A single sealing head 1810 may be provided, which may be connected to a robotic arm and/or gantry robot under control of controller 1660 to relocate and seal a plurality of vials. Alternatively, a plurality of sealing heads may be provided. These may be under the control of the controller 1660, and may be designated to a single vial location within the system 1000, or they may be connected to a robotic arm and/or gantry robot under control of controller 1660 to relocate and seal a plurality of vials at a plurality of vial locations.

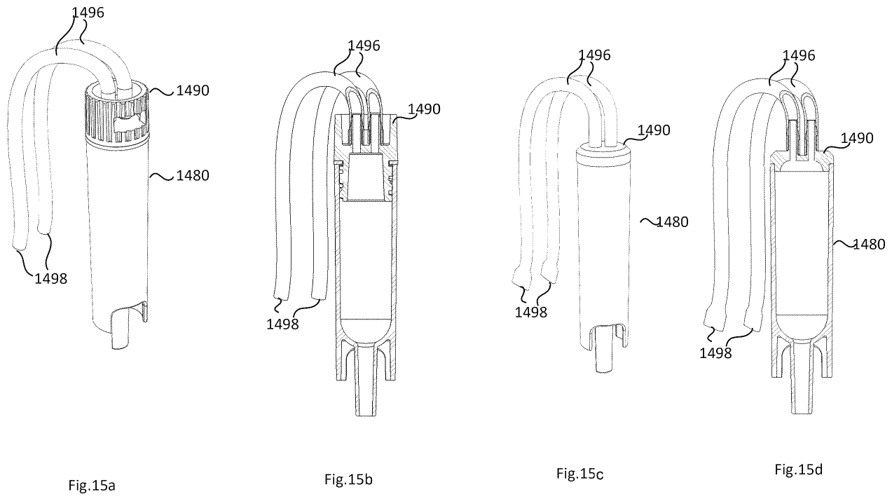

FIG. 15a is a schematic illustration of an alternative vial design which provides sterile access into the interior of vial 1480. Access ports 1496 are provided in the form of sealed sterile tubes 1496 that are anchored in primary closure 1490 and open into the interior of vial 1480. FIG. 15b is a sectional view of the vial of FIG. 15a illustrating one arrangement of tubes 1496 in the primary closure 1490 although it is to be understood that the tubes may extend further inside the vial 1480 in some examples. Access ports 1496 are provided with a sterile closure 1498 distally of the primary closure 1490 to prevent contamination. The sterile closure 1498 may be cut from the tubes 1496 using a sterile weld or other sterile instrument just prior to use of the access ports to provide access to the vial. Access ports 1496 may be used to permit introduction and/or removal of e.g. fluid, without removal of the primary closure 1490. When access ports 1496 are used to introduce and/or remove e.g. fluid, the introduction of these fluids can be achieved aseptically. This enables vials to be connected with an existing sterile process by sterile tube connection via the access ports 1496. While the vial exemplified in FIGS. 15a and 15b corresponds to the vial example shown in FIGS. 7 to 11b, it is to be understood that the access ports may similarly be incorporated into the vial example shown in FIGS. 14a to 14i. Furthermore, the access ports exemplified in FIGS. 15a and 15b may also be incorporated into an example in which the primary closure 1490 is a lid sealed or welded over the vial first opening. An example of a vial with primary closure 1490 comprising a sealed or welded lid is shown schematically in FIG. 15c, with a cross sectional view shown in FIG. 15d. Access ports may be incorporated e.g. by co-moulding the lid with the tubes 1496.

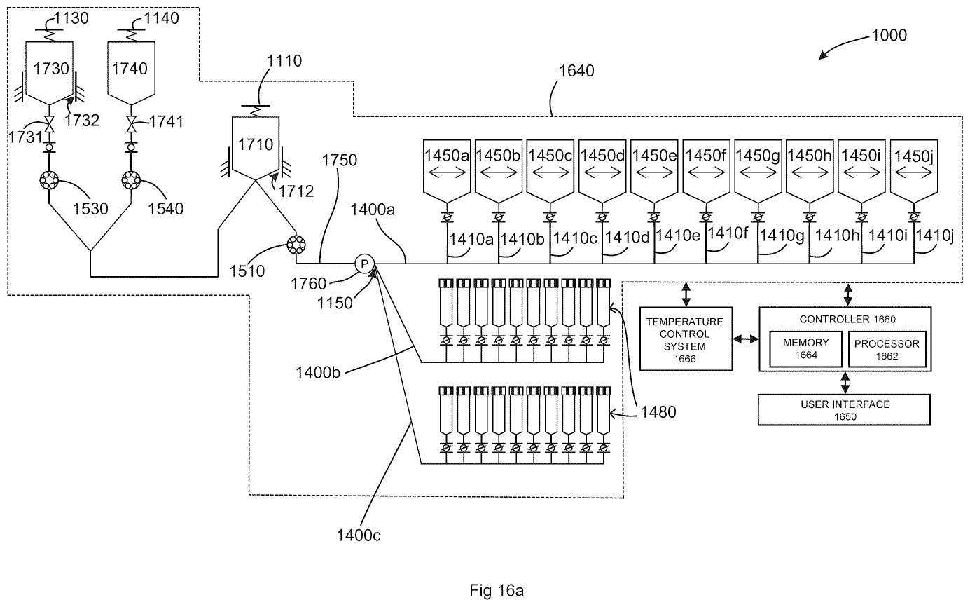

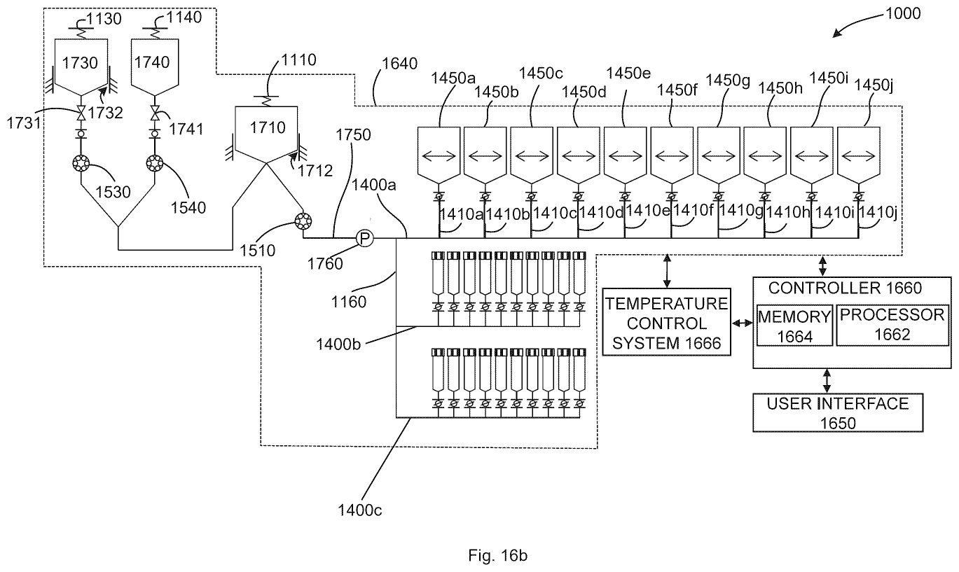

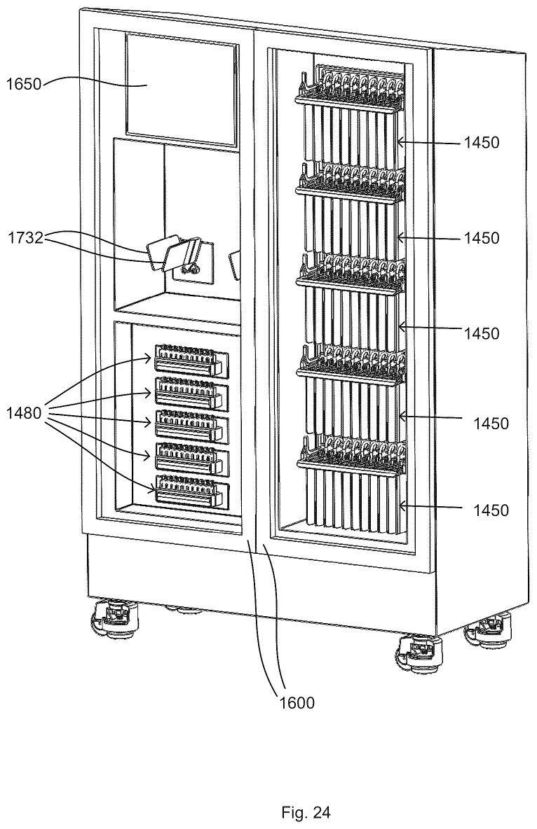

Advantageously, systems of the present disclosure may be configured to accommodate multiple manifolds 1400 simultaneously, using multiple retaining members 1200 which can be incorporated into the system in a modular manner. In some embodiments, system 1000 may be configured to fill containers comprising bags 1450 in fluid communication with a first manifold and vials 1480 in communication with a second manifold, wherein the bags and vials are filled from a common fluid source. Schematic diagrams showing suitable fluid flow arrangement to achieve this is provided in FIGS. 16a and 16b which provide for aseptic filling of 10 flexible (bag) containers on a first manifold 1400a and 20 rigid (vial) containers comprised of 10 vials on a second manifold 1400b and 10 vials on a third manifold 1400c. The manifolds may be fluidly coupled with the flow path via a hub 1150 as shown in FIG. 16a or via a branched conduit 1160 as shown in FIG. 16b. In some embodiments, valves (not shown) may be provided to control flow to ones of the manifolds for filling of the associated containers. Such valves may be operated under control of controller 1660 when provided. Thus, design of the system is flexible and capable of achieving sterile filling of tens, hundreds or several thousand containers in a controlled aseptic environment. One example of a system 5000 for sterile filling of flexible bags 1450 and vials 1480 is shown in FIG. 24. Such a system illustrates the potential for modularity and scalability of the system for use in sterile filling of containers in a manner which is safer and more efficient than existing approaches and which, for cell products, can maximise cell yield with precise and homogenous formulation for both flexible containers (e.g. bags) and vials.

Through calibration using containers of known type containing a known volume, the system is configurable to fill containers having different type or volume. Once the controller is programmed with the calibration settings for known container types and volumes, the separation distance of the separation members for flexible containers, and evacuation pressure for rigid vials, can be store in memory 1664 of controller 1660 for future use. Alternatively/additionally, the controller memory 1664 may be pre-loaded with the required values for use by the controller 1660 in controlling positioning of the spacing members and operation of the fluid control features according to the target fill volume required by the operator using the user interface 1650. Thus, the system is operable to alter the target fill volume for the totality of containers attached to the fluid path 1750 by controlling one or more of fluid pressure in the flow path, flow rate and time, and for flexible containers, separation between spacing members of the retaining member.

Furthermore, for flexible containers the system is operable to alter the target fill volume for one or more of the containers attached to a manifold by a process of staged filling and sealing. To achieve different target fill volumes for different flexible containers on a single manifold, the controller causes the system to operate to fill the unsealed containers to a first target volume, seal the containers that require only the first target volume, widen the space between spacing members to permit a higher fill volume, continue to fill the unsealed containers to a second target volume larger than the first target volume, seal the containers that require only the second target volume, and repeat until all containers have been filled to the various target fill volumes required by the operator.

While examples described herein provide 10 containers such as bags or vials on a manifold 1400, it is to be understood that the system 1000 is flexible and can be configured to accommodate manifolds with fewer containers, or with more containers. For example, the system may be configured to operate with a manifold in fluid communication with e.g. 2, 3, 4, 5, 6, 7, 8, 9, 15, 20, 25, 30, 40, 50, 60, 70, 80, 90 or 100 or more containers per manifold.

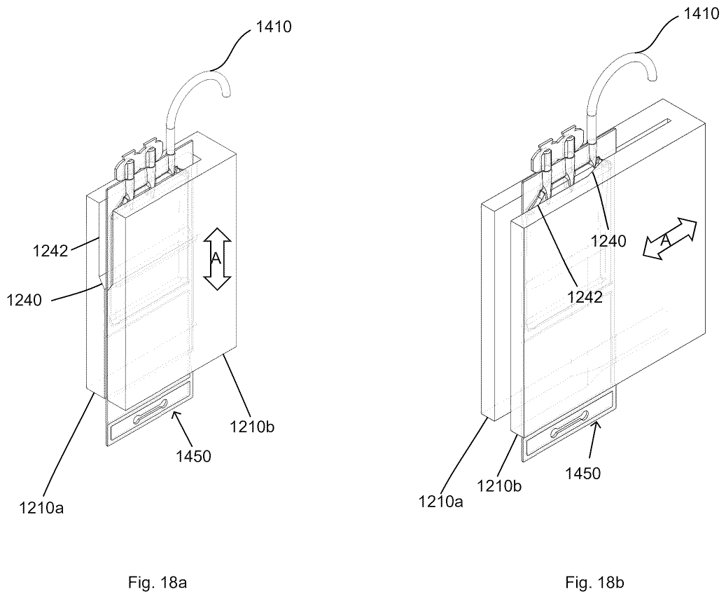

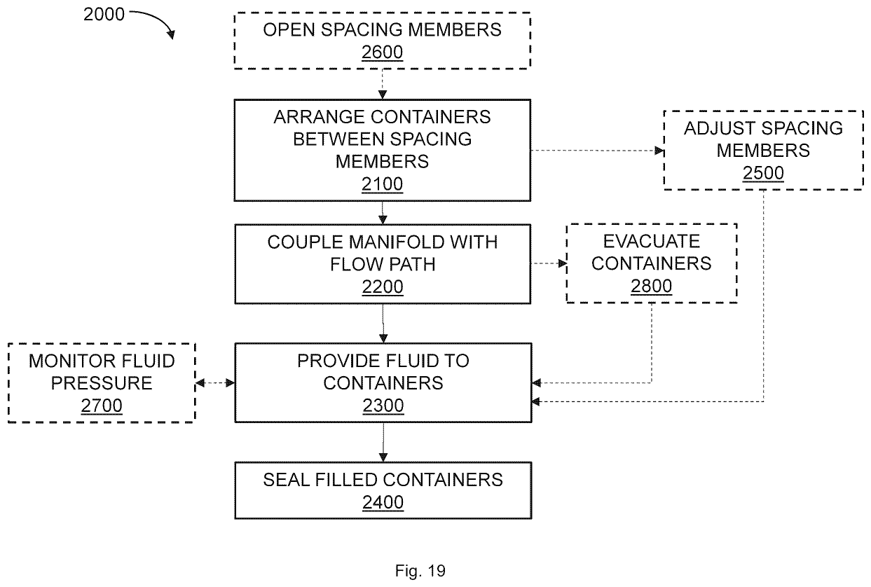

FIG. 19 is a flow chart illustrating steps in a method 2000 for sterile filling of containers, such as sterile flexible bag containers, in a filling system such as embodiments of the system 1000 described herein. Optional steps are shown in broken-line. In a step 2100, a plurality of containers are arranged in a filling system having spacing members. The plurality of containers are each in fluid communication with a manifold via a corresponding manifold limb and are arranged such that one (or more) containers are located between the spacing members which themselves are arranged to limit container expansion during filling. This may involve use of a rack for handling the manifold and the plurality of containers for loading and/or unloading the containers into the system.

In a step 2200, the manifold is coupled with a flow path of the system, typically by a sterile seal, providing fluid communication between a fluid source and the plurality of containers. In a step 2300, the fluid is provided into the one or more containers via the manifold until a target fill volume is reached and in a step 2400, the containers are sealed. It may be preferred that sealing of containers is achieved while pressure in the flow path is maintained at the target pressure.

In some embodiments, prior to filling step 2300, the space between the spacing members can be adjusted in a step 2500 to adjust extent to which the containers may expand during filling, thereby adjusting the target fill volume. Thus, the method can be modified to fill containers on the manifold to a different target volume.

In some embodiments, prior to arranging the containers in step 2100, the spacing members may be moved so as to open a space between them in step 2600, for ease of receiving the containers between the spacing members. In some embodiments, the containers may be inserted on an angle so as to reduce the amount of the container's leading edge that needs to be directed into the space between the spacing members. After the containers are arranged between the spacing members, the spacing members may be adjusted as in step 2500 to correspond with the target fill volume. In a step 2700, the method may comprise monitoring fluid pressure during filling and terminating flow to the plurality of containers when the monitored fluid pressure reaches a target pressure.

Typically, the flow of fluid provided in step 2300 is provided by operating a pressure source such as a pumping mechanism (e.g. comprised of one or more peristaltic pumps) to provide the flow of fluid as described previously. In some embodiments, prior to providing the fluid to the containers in step 2300, the method may comprise operating a negative pressure source in step 2800 to evacuate the plurality of containers before filling. This may assist with container leak detection and provide an additional level of safety/accuracy by ensuring that the bag is expanded and not sticking or bunching/gathering during the fill process.

In some embodiments, the method may be modified so as to seal a subset of containers prior to filling. This may be desirable e.g. when the supply of fluid is insufficient to fill all containers on the manifold to the target volume. In such a method, sealing step 2400 may be applied prior to the filling step 2300 in respect of any one or more of the containers on the manifold that do not require filling. Thus, the sealed empty containers will be excluded from the fluid flow path prior to filling.

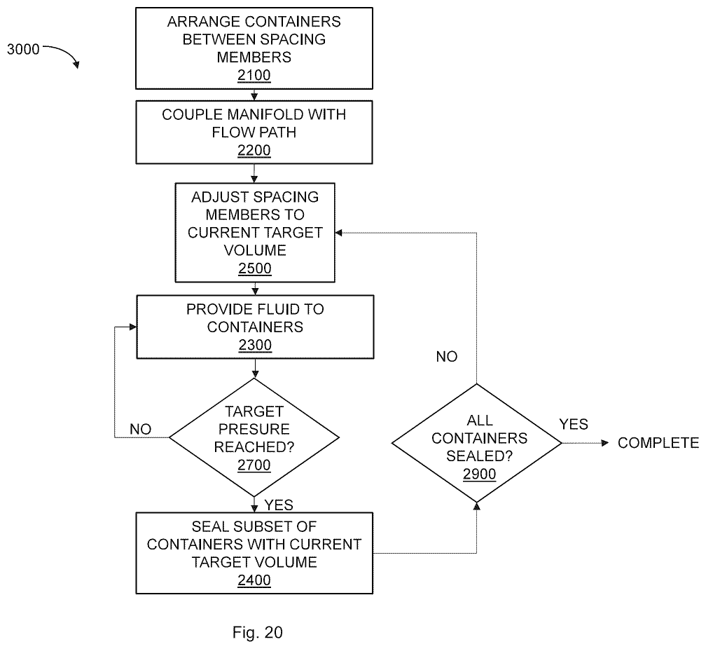

Alternatively/additionally, the method may be modified so as to seal a subset of containers after filling step 2300 to fill different containers on the manifold to different target volumes. Such a method 3000 is illustrated in FIG. 20 which, for simplicity only, omits optional steps 2600, 2800 which may also form part of the modified method 3000. The plurality of containers on a manifold are arranged between the spacing members in step 2100 and the manifold is coupled with the flow path in step 2200. The spacing members are adjusted to fill to a “current” target volume in step 2500 being the smallest volume to which a subset of containers on the manifold are to be filled. Fluid is provided to the containers in filling step 2300. Pressure is monitored in step 2700 and when the target pressure has been reached, the subset of containers requiring only the “current” target volume are sealed. If there are unsealed containers remaining on the manifold, in step 2900 the spacing members are adjusted again at step 2500 to a new “current” target volume which is higher than the previous target volume and fluid is provided to the unsealed containers in filling step 2300. Steps 2300, 2700, 2400 and 2900 are repeated until all the containers are sealed, which signifies that filling of containers on the manifold is complete. Sealing the containers may also detach the containers from the manifold, or detachment may involve a separate cutting step.

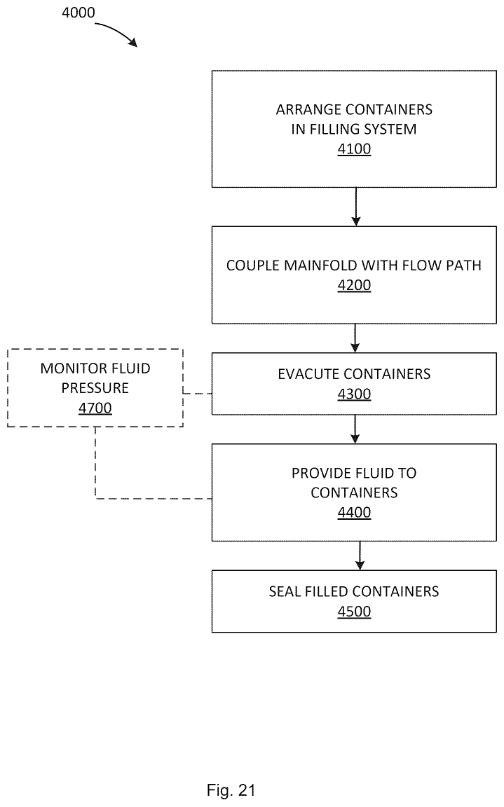

FIG. 21 is a flow chart illustrating steps in a method 4000 for sterile filling of containers, such as rigid containers (e.g. vials) in a filling system such embodiments of the system 1000 described herein. Optional steps are shown in broken-line. In a step 4100, a plurality of containers are arranged in a filling system, the plurality of containers each being in fluid communication with a manifold via a corresponding manifold limb. This may involve use of a rack for handling the manifold and the plurality of containers for loading/unloading the containers into the system.

In a step 4200 the manifold is coupled with a flow path of the system, typically by a sterile seal, providing fluid communication between a fluid source and the plurality of containers. In a step 4300, a negative pressure source is operated to evacuate the containers to a target evacuation pressure before filling. In a step 4400 a flow of the fluid is provided to the one or more evacuated containers via the manifold until pressure in the flow path reaches a predetermined target pressure and in a step 4500 the containers are sealed. In a step 4700 the method may comprise monitoring fluid pressure within the flow path to ascertain if it has reached a target pressure. The target pressure may correspond to pressure in the flow path equalising to atmosphere, or it may be set to maintain a degree of evacuation (negative pressure) or a residual positive pressure in the containers if the fluid is actively pumped into the containers.

Sealing the containers may also detach the containers from the manifold, or detachment may involve a separate cutting step. Using this filling technique, owing to the rigid nature of the containers being filled, the target evacuation pressure is determinative of volume to which the containers are filled when the fluid is provided in step 4400. It may be preferred that sealing of containers is achieved while pressure in the flow path is maintained at the target pressure.

Fluid flow from the flow source to the one or more evacuated containers may be flow rate controlled e.g. by use of one or more of a pump mechanism (such as a peristaltic pump) as described elsewhere and/or a flow rate restrictor.

In some embodiments, the method 4000 may be modified so as to seal a subset of containers prior to filling. This may be desirable e.g. when the supply of fluid is insufficient to fill all containers on the manifold. In such a method, sealing step 4500 may be applied prior to the filling step 4400 in respect of any one or more of the containers on the manifold that do not require filling. Thus, the sealed empty containers will be excluded from the fluid flow path prior to filling.

All or part of the methods disclosed herein such as e.g. methods 2000, 3000, 4000 may be automated by use of a controller comprising a processor executing instructions for controlling operation of one or more of a pump providing the flow of fluid and/or evacuating containers, a sealing mechanism for sealing the containers, and a thermal system for temperature control of the fluid. Filling methods 2000, 3000 may also utilise a controller for adjustment of the spacing members.

Embodiments of the present disclosure provide novel approaches to sterile filling of containers such as flexible bags and rigid vials in a manner that achieves reliable volumes without the need to perform a check weigh as is commonly required in existing filling systems. This makes the filling process faster and more efficient. In addition to providing advantages in throughput, cells spend less time in cryopreservative before freezing than other known processes reducing cytotoxicity issues. Thus, an advantage may arise not only due to faster processing, which is inherently more valuable, but also due to cell death reduction which is a consequence of the improved processing speed.

Embodiments of the present disclosure have utility in the formulation and filling of containers with cell product for patient administration and/or quality control. The present invention provides a platform for a faster, more efficient and consistent process that reduces variability seen in other approaches, particularly between filled bags and QC vials. Automated embodiments reduce or eliminate operator intervention and embodiments providing a closed environment can be operated in a Grade C/D space avoiding the cost associated with operating a Class A space in both space and personnel requirements. Additionally, embodiments of the present disclosure may be useful across a range of other applications including media and ancillary materials manufacturing, chemotherapy and radiological preparations, cell banking by sterile filling of vials for master/working cell banks (MCB/WCB), small-volume parenterals (such as autologous CAR-T) and various natural and engineered biologicals such as secretomes, antibodies, viruses and DNA/RNA. While embodiments disclosed herein have variously described formulation and fill processes, it is to be understood that the present disclosure is not to be limited to these combined processes. Specifically the present disclosure is directed to systems and methods for sterile filling of containers without a formulation/mixing process.

The systems and methods disclosed herein can provide aseptic and highly controlled approaches to filling of fluids into containers such as bags and vials. In some embodiments the processes may be semi- or fully automated reducing risks associated with known formulate and fill techniques, and providing rapid throughput and a highly scalable platform. Because the sterile fluid flow path can be provided by a conduit that is disposable between the fluid source receptacle and the manifold, no residual fluid is retained in the system. Therefore, the system can be rapidly changed over from filling of one media type to another without the need to flush or sterilise the system. Because the system is modular and adaptable for a range of applications, it may provide an attractive alternative to larger, application specific systems that require significant capital investment.

The present disclosure provides opportunities to improve cell yield by limiting deterioration of cells particularly during container filling when compared with manual filling techniques. Owing to the modular and scalable design of the system, batch sizes can increase since the process is not limited by the throughput of a human resource.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components or group thereof.

It is to be understood each of the various aspects, embodiments and examples described herein may incorporate features, modifications and alternatives described in the context of one or more other aspects, embodiments and examples, such as but not limited to the various systems and methods for sterile filling of containers e.g. as they may be described for flexible containers (e.g. bags) and/or rigid containers (e.g. vials). For efficiency, such features, modifications and alternatives have not been repetitiously disclosed for each and every aspect, embodiment and example. It is to be appreciated that such combinations of features, modifications and alternatives disclosed for some aspects, embodiments and examples apply similarly for other aspects, embodiments and examples and are within the scope of and are be taken to expressly form part of this disclosure.

It is to be understood that various modifications, additions and/or alterations may be made to the parts previously described without departing from the ambit of the present invention as defined in the provisional claims appended hereto.

Future patent applications may be filed on the basis of or claiming priority from the present application. It is to be understood that the following claims are provided by way of example only, and are not intended to limit the scope of what may be claimed in any such future application. Features may be added to or omitted from the claims at a later date so as to further define or re-define the invention or inventions.

1-111. (canceled)

112. A system for sterile filling of substantially rigid containers, the system comprising:
a fluid source receiver for receiving fluid to be filled into the containers;
a pumping mechanism operable to evacuate some or all of the containers prior to filling; and
a sealing mechanism operable to seal the containers from the fluid source;
wherein the containers are in fluid communication with a manifold having a plurality of manifold limbs and wherein the manifold is configured to provide a flow path between a fluid source received in the fluid source receiver and ones of the containers; and
wherein containers are filled by providing a flow of the fluid to the one or more evacuated containers via the manifold until pressure in the flow path reaches a target pressure.

113. The system according to claim 112, wherein the flow path between the fluid source and the plurality of containers is a closed fluid system preventing entry of contaminants during use of the system to fill the containers.

114. The system according to claim 112, wherein the sealing mechanism also detaches the sealed containers from the manifold.

115. The system according to claim 112, further comprising a fluid pressure sensor in the flow path, wherein a controller is configured to control operation of the pumping mechanism to evacuate the containers to a target evacuation pressure correlated to a target fill volume.

116. The system according to claim 112, wherein the containers comprise substantially rigid sterile vials in fluid communication with ones of the manifold limbs of the manifold, wherein the substantially rigid vials each comprise a neck portion defining an opening for receiving the fluid to be filled into the containers.

117. The system according to claim 116, wherein the substantially rigid vials each comprise one or more of:
the neck portion or part thereof comprises a cross-sectional shape selected from a group comprising a: circle, oval, ellipse and obround;
a vial wall around at least part of the neck portion, the vial wall comprising an opening for receiving the sealing mechanism to seal the neck portion;
a vial wall providing a base for standing the vial when filled and detached from the manifold;
a shield around at least part of the portion of the neck portion, the shield configured to protect at least part of the neck portion.

118. The system according to claim 116, wherein the rigid vials are couplable or co-moulded with a manifold, and optionally wherein the manifold comprises a recessed region aligned with a vial second opening receiving fluid from the manifold, and configured to receive a sealing head which deforms the recessed region, to seal the vial opening.

119. The system according to claim 116, wherein the vials each comprise a primary closure for access to the vial once filled and optionally, wherein the primary closure is selected from a group comprising: a screw top, a sealed septum, a welded lid, a tear away seal, and a sterile access port.

120. The system according to claim 112, configured for one or more of:
receiving more than one manifold simultaneously;
accommodating multiple manifolds fluidly coupled with the flow path via a hub;
accommodating multiple manifolds fluidly coupled with the flow path via a branched conduit;
filling at least a subset of containers in fluid communication with a manifold; and
receiving a rack carrying the plurality of containers before filling, wherein the rack is removable with the sealed containers.

121. The system according to claim 112, comprising a mixing reservoir that is preferably temperature controlled and optionally, wherein the mixing reservoir comprises at least one thermally conductive member.

122. The system according to claim 112, wherein the sealing mechanism comprises one or more of an impulse, radio frequency or heat sealing mechanism or a crimping mechanism configured to seal individual ones of the containers; and optionally, wherein the sealing mechanism also detaches the sealed containers from the manifold.

123. The system according to claim 112, further comprising a retaining member comprising one or more spacing members defining spaces arranged to limit flexible container expansion during filling to achieve a target fill volume for at least one of a plurality of sterile flexible containers, and further comprising one or more of:
the spacing members being adjustable;
the spacing members comprising walls defining spaces for accommodating at least individual ones of the plurality of containers therebetween and optionally, wherein at least every second wall is moveable, and further optionally wherein moveable walls move in concert or are independently moveable;
the spacing members comprising walls wherein at least every second wall has non-uniform thickness.

124. The system according to claim 123 comprising a controller, wherein the controller is configured to perform one or both of:
determine a required spacing between the walls to achieve the target fill volume for at least one of the plurality of containers; and
determine a different defined space to achieve a different target fill volume for at least one of the plurality of containers.

125. The system according to claim 112, wherein the system is configurable to fill containers comprising flexible containers in fluid communication with a first manifold and substantially rigid vials in communication with a second manifold, wherein the flexible containers and substantially rigid vials are filled from a common fluid source.

126. A method for sterile filling of containers in a filling system, comprising the steps of:
arranging a plurality of the containers in the system, the plurality of containers each being in fluid communication with a manifold via a corresponding manifold limb;
coupling the manifold with a flow path providing closed fluid communication between a fluid source and the plurality of containers;
operating a negative pressure source to evacuate the containers to a target evacuation pressure before filling;
providing a flow of the fluid to the one or more evacuated containers via the manifold until pressure in the flow path reaches a target fill pressure; and
sealing the containers;
wherein the target evacuation pressure is determinative of volume to which the containers are filled; and
wherein the containers are substantially rigid sterile containers, preferably vials.

127. The method according to claim 126, wherein fluid flow from the flow source to the one or more evacuated containers is flow rate controlled by use of one or more of:
a pump mechanism; and
a flow rate restrictor.

128. The method according to claim 126, comprising one or more of:
sealing a subset of the containers prior to filling;
loading the manifold and the plurality of containers into the system using a rack;
removing the plurality of sealed containers from the system using the rack;
detaching the sealed containers from the manifold after filling and sealing, or after filling and substantially simultaneously with sealing.

129. A method for sterile filling of containers using the system according to claim 112.

130. A sterile container comprising:
a container body having a first opening with a primary closure for providing user access to sterile fluid when the container is filled; and
a second opening for receiving a sterile fluid to be filled into the container;
wherein the second opening is configured to be sealed after filling.

131. The sterile container according to claim 130 comprising a neck portion defining the second opening, wherein the neck portion is configured to be coupled with a manifold such that the manifold can receive a plurality of the sterile containers to be filled.

132. The sterile container according to claim 131, comprising one or more of:
a wall portion around at least part of the neck portion, the wall portion comprising an opening for providing access to the neck portion while also providing a base for standing the container;
the neck portion or part thereof comprises a cross-sectional shape selected from a group comprising a: circle, oval, ellipse and obround; and
a shield around at least part of the neck portion, the shield configured to protect at least part of the neck portion.

133. The sterile container according to claim 131, wherein the neck portion is couplable or co-molded with a manifold, and optionally wherein the manifold comprises a recessed region aligned with the vial second opening and configured to receive a sealing head which deforms the recessed region to seal the vial second opening and optionally separate the vial from the manifold.

134. The sterile container according to claim 130, wherein the primary closure is selected from a group comprising: a screw top, a sealed septum, a welded lid, and a tear away seal.

135. The sterile container according to claim 130, comprising one or more sterile access ports provided through the primary closure.
